(19) United States
(12) Patent Application Publication
(10) Pub. No.: US 2025/0321400 A1
(43) Pub. Date: Oct. 16, 2025

(54) OPTICAL SYSTEM AND CAMERA MODULE COMPRISING SAME

(71) Applicant: LG INNOTEK CO., LTD., Seoul (KR)

(72) Inventor: Doo Shik SIN, Seoul (KR)

(21) Appl. No.: 18/865,409

(22) PCT Filed: May 22, 2023
(86) PCT No.: PCT/KR2023/006931

§ 371 Date: Nov. 13, 2024

(30) Foreign Application Priority Data
May 20, 2022 (KR) 10-2022-0062221

(51) Int. Cl. G02B 9/64

(52) U.S. Cl. CPC G02B 9/64

(57) ABSTRACT

The optical system disclosed in the embodiment of the invention includes first to eleventh lenses disposed along an optical axis in a direction from an object side to a sensor side, wherein the first lens has positive (+) refractive power on the optical axis and has a convex object-side surface, and a refractive index n3 of the third lens and a refractive index n4 of the fourth lens satisfy the following Equation: 1<n3/n4<1.5, a number of meniscus-shaped lenses convex toward the object side on the optical axis OA of the first to eleventh lenses is four or more, a sensor-side surface of the eleventh lens is provided without a critical point from the optical axis to an end of an effective region, and a maximum distance from the optical axis to a point where a height between a straight line orthogonal to the optical axis and the sensor-side surface is less than 0.1 is a first distance, and the first distance may be disposed at a position of 20% or more of an effective radius of the sensor-side surface of the eleventh lens.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. The embodiment provides an optical system having excellent optical performance at the center and periphery portions of the field of view. The embodiment provides an optical system capable of having a slim structure.

### Technical Solution

An optical system according to an embodiment of the invention comprises first to eleventh lenses disposed along an optical axis in a direction from an object side to a sensor side, wherein the first lens has positive (+) refractive power on the optical axis and has a convex object-side surface, and a refractive index n3 of the third lens and a refractive index n4 of the fourth lens satisfy the following Equation: 1<n3/n4<1.5, a number of meniscus-shaped lenses convex toward the object side on the optical axis OA of the first to eleventh lenses is four or more, a sensor-side surface of the eleventh lens is provided without a critical point from the optical axis to an end of an effective region, and a maximum distance from the optical axis to a point where a height between a straight line orthogonal to the optical axis and the sensor-side surface is less than 0.1 is a first distance, and the first distance may be disposed at a position of 20% or more of an effective radius of the sensor-side surface of the eleventh lens.

According to an embodiment of the invention, a difference between a maximum slope angle (L10S2_max slope) of a tangent passing through the sensor-side surface of the tenth lens and a maximum slope angle (L11S2_max slope) of a tangent passing through the sensor-side surface of the eleventh lens may satisfy the following Equation: 10<|L11S2_max slope|−|L10S2_max slope|<30. An effective radius of the sensor-side surface of the eleventh lens may be less than 5 mm.

According to an embodiment of the invention, a difference between a maximum slope angle (L10S2_max slope) of a tangent passing through the sensor-side surface of the tenth lens and a maximum slope angle (L11S2_max slope) of a tangent passing through the sensor-side surface of the eleventh lens may satisfy the following Equation: −5<|L11S2_max slope|−|L10S2_max slope|<5. An effective radius of the sensor-side surface of the eleventh lens may be 6 mm or more.

According to an embodiment of the invention, an effective diameter CA_L11S2 of the eleventh lens and a center distance CG10 between the tenth and eleventh lenses may satisfy the following condition: 3<CA_L11S2/CG10<20. The effective diameter CA_L10S2 of the tenth lens and the center distance CG10 between the tenth and eleventh lenses may satisfy the following Equation: 5<CA_L11S2/CG10<15.

According to an embodiment of the invention, a maximum effective diameter CA_Max of the object-side surface and the sensor-side surface of the first to eleventh lenses and a distance ImgH from a center of an image sensor to a diagonal end thereof may satisfy the following Equation: 0.5≤CA_Max/(2*ImgH)<1.

According to an embodiment of the invention, refractive indices n1, n2 and n3 of the first to third lenses may satisfy the following equations: 1.50<n1<1.6, 1.50<n2<1.6, and 17<n3*n (n is a total number of lenses).

According to an embodiment of the invention, the first, second, third and seventh lenses may have a meniscus shape convex from the optical axis toward the object side. The tenth and eleventh lenses may have a meniscus shape convex from the optical axis toward the sensor side.

According to an embodiment of the invention, a sum ΣCA of the effective diameters of the object-side surface and the sensor-side surface of the first to eleventh lenses satisfies the following condition: ΣCA*n>1100, and n may be a total number of lenses.

An optical system according to an embodiment of the invention includes a first lens group having a plurality of lenses aligned along an optical axis at an object side; a second lens group having a plurality of lenses aligned along the optical axis at a sensor side of the first lens group; and a aperture stop disposed around any one lens of the first lens group, wherein a number of lenses of the second lens group is more than twice a number of lenses of the first lens group, the lenses of the first lens group have a meniscus shape convex toward the object side on the optical axis, a n-th lens closest to an image sensor in the second lens group and a n−1th lens disposed on an object-side of the n-th lens have a meniscus shape convex toward the sensor side on the optical axis, a sensor-side surface of a lens closest to the second lens group among the lenses of the first lens group has a concave shape on the optical axis, an object-side surface of a lens closest to the first lens group among the lenses of the second lens group has a concave shape on the optical axis, effective diameters of an object-side surface and a sensor-side surface of first to third lenses gradually decrease from the object side toward the sensor side, and effective diameters of the lenses in the second lens group may gradually increase from an effective diameter of the object-side surface of the lens closest to the first lens group to an effective diameter of a sensor-side surface of a last lens closest to the image sensor.

According to an embodiment of the invention, the effective diameters of the lenses in the first lens group may gradually increase from the effective diameter of the sensor-side surface of the lens closest to the second lens group to the effective diameter of the object-side surface of the first lens.

According to an embodiment of the invention, a distance from the image sensor to a center of the sensor-side surface of the last lens may be equal to a distance from a maximum Sag value of the sensor-side surface of the last lens to the image sensor.

According to an embodiment of the invention, a minimum effective diameter CA_Min and a maximum effective diameter CA_Max among the lenses of the first and second lens groups satisfy the following equation: 50<(CA_Max−CA_Min)*n<120, and n may be a total number of lenses.

According to an embodiment of the invention, a difference between an optical axis distance TD_LG1 of the first lens group and an optical axis distance TD_LG2 of the second lens group may satisfy the following Equation: 21<(TD_LG2/TD_LG2)*n<31 (n is the total number of lenses).

According to an embodiment of the invention, a maximum center thickness CT_Max of the lenses of the first and second lens groups and a maximum center distance CG_Max between adjacent lenses may satisfy the following Equation: 5<(CT_Max+CG_Max)*n<12 (n is the total number of lenses).

According to an embodiment of the invention, a lens having the maximum center thickness may be a first lens, and two lenses having the maximum center distance may be the n-th lens and the n−1th lens.

According to an embodiment of the invention, the first lens group includes first to third lenses, the second lens group includes fourth to eleventh lenses, and a composite focal length from the first lens to the third lens is F13 and a composite focal length from the fourth lens to the eleventh lens is F411, and the following Equation may satisfy: 3<|F411/F13|<15.

A camera module according to an embodiment of the invention includes an image sensor; and an optical filter disposed between the image sensor and a last lens, wherein an optical system includes an optical system disclosed above, and the following Equations: 0.5<F/TTL<1.5, 0.5<TTL/ImgH<3, and 40≤ImgH*n<120 (F is an average of total focal lengths in two directions orthogonal to the optical axis of the optical system, and TTL (Total track length) is a distance from a center of an object-side surface of the first lens to an image surface of the image sensor in the optical axis, ImgH is ½ of a maximum diagonal length of the image sensor, and n is the total number of lenses).

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the field of view (FOV). The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to a first embodiment of the invention.

FIG. 2 is an explanatory diagram illustrating a relationship between an image sensor, an n-th lens, and an n−1th lens of the optical system of FIG. 1.

FIG. 3 is a table showing lens data of the optical system of FIG. 1.

FIG. 4 is an example of aspherical surface coefficients of lenses according to the first embodiment of the invention.

FIG. 5 is a table showing thicknesses of lenses and intervals between lenses according to a direction orthogonal to an optical axis in an optical system according to a first embodiment of the invention.

FIG. 6 is a table showing Sag values of object-side surfaces and sensor-side surfaces of tenth to eleventh lenses in the optical system of FIG. 1.

FIG. 7 is a graph of diffraction MTF of the optical system of FIG. 1.

FIG. 8 is a graph showing aberration characteristics of the optical system of FIG. 1.

FIG. 9 is a graph showing Sag values of object-side surfaces and sensor-side surfaces of tenth and eleventh lenses of the optical system of FIG. 1.

FIG. 10 is a configuration diagram of an optical system and a camera module according to a second embodiment of the invention.

FIG. 11 is a table showing lens data of the optical system of FIG. 10.

FIG. 12 is an example of aspherical surface coefficients of lenses of the optical system of FIG. 10.

FIG. 13 is a table showing thicknesses of lenses and intervals between lenses in the optical system of FIG. 10 according to a direction orthogonal to an optical axis.

FIG. 14 is a table showing Sag values of object-side surfaces and sensor-side surfaces of tenth to eleventh lenses in the optical system of FIG. 10.

FIG. 15 is a graph of diffraction MTF of the optical system of FIG. 10.

FIG. 16 is a graph showing aberration characteristics of the optical system of FIG. 10.

FIG. 17 is a graph showing Sag values of object-side surfaces and sensor-side surfaces of tenth and eleventh lenses of the optical system of FIG. 10.

FIG. 18 is a configuration diagram of an optical system and a camera module according to a third embodiment of the invention.

FIG. 19 is a table showing lens data of the optical system of FIG. 18.

FIG. 20 is an example of aspherical surface coefficients of lenses of the optical system of FIG. 18.

FIG. 21 is a table showing thicknesses of lenses and intervals between lenses in the optical system of FIG. 18 according to a direction orthogonal to an optical axis.

FIG. 22 is a table showing Sag values of object-side surfaces and sensor-side surfaces of tenth to eleventh lenses in the optical system of FIG. 18.

FIG. 23 is a graph of diffraction MTF of the optical system of FIG. 18.

FIG. 24 is a graph showing aberration characteristics of the optical system of FIG. 18.

FIG. 25 is a graph showing Sag values of the object-side surface and the sensor-side surface of the tenth and eleventh lenses of the optical system of FIG. 18.

FIG. 26 is a configuration diagram of an optical system and a camera module according to a fourth embodiment of the invention.

FIG. 27 is a table showing lens data of the optical system of FIG. 26.

FIG. 28 is an example of aspherical surface coefficients of the lenses of the optical system of FIG. 26.

FIG. 29 is a table showing thicknesses of lenses and intervals between lenses in the optical system of FIG. 26 according to a direction perpendicular to the optical axis.

FIG. 30 is a table showing Sag values of object-side surfaces and sensor-side surfaces of tenth to eleventh lenses in the optical system of FIG. 26.

FIG. 31 is a graph of diffraction MTF of the optical system of FIG. 26.

FIG. 32 is a graph showing aberration characteristics of the optical system of FIG. 26.

FIG. 33 is a graph showing Sag values of the object-side surface and the sensor-side surface of the tenth and eleventh lenses of the optical system of FIG. 26.

FIG. 34 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

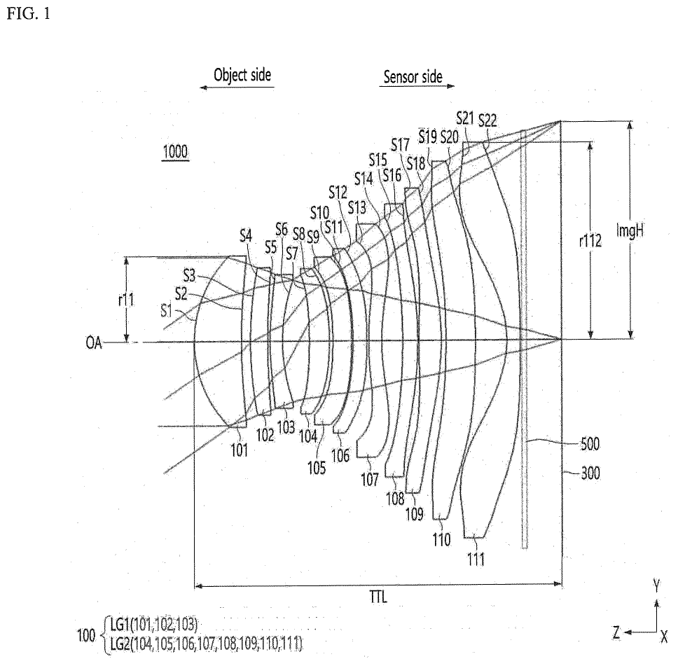

FIGS. 1, 10, 18 and 26 are diagrams illustrating an optical system 1000 and a camera module having the same according to embodiments of the invention.

Referring to FIGS. 1, 10, 18, and 26, an optical system 1000 or a camera module may include lens portions 100, 100A, 100B, and 100C having a plurality of lens groups LG1 and LG2. In detail, each of the plurality of lens groups LG1 and LG2 includes at least one lens. For example, the optical system 1000 may include a first lens group LG1 and a second lens group LG2 sequentially disposed along the optical axis OA toward the image sensor 300 from the object side. The number of lenses of the second lens group LG2 may be greater than the number of lenses of the first lens group LG1, for example, between two times and three times the number of lenses of the first lens group LG1.

The first lens group LG1 may include two or more and four or less lenses, for example, two to three lenses. The second lens group LG2 may include five or more lenses. The second lens group LG2 may include more lenses than the number of lenses of the first lens group LG1, for example, 9 or less or 7 or more lenses. The number of lenses of the second lens group LG2 may be greater than the number of lenses of the first lens group LG1 by 7 or more, for example, 8 or more. The total number of lenses of the first and second lens groups LG1 and LG2 is 10 to 12. For example, the first lens group LG1 may include 3 lenses, and the second lens group LG2 may include 8 lenses.

In the optical system 1000, a total track length (TTL) may be less than 94% of the diagonal length of the image sensor 300, and may be, for example, in the range of 60% to 90% or 70% to 90%. TTL is a distance on the optical axis OA from the object-side surface of the first lens 101 closest to the object side to the image surface of the image sensor 300, and the diagonal length of the image sensor 300 is the maximum diagonal length of the image sensor 300, and may be, for example, twice a distance ImgH from the optical axis OA to the diagonal end. Accordingly, it is possible to provide a slim optical system and a camera module having the same.

The first lens group LG1 refracts the light incident through the object side to converge, and the second lens group LG2 converts the light emitted through the first lens group LG1 so as to diffuse to the periphery of the image sensor 300. Here, the sensor-side surface of the lens closest to the second lens group LG2 in the first lens group LG1 has a concave shape on the optical axis OA, and the second lens group LG2 has a concave shape. An object-side surface of a lens closest to the first lens group LG1 may have a convex shape on the optical axis OA. That is, two surfaces facing each other in the first and second lens groups LG1 and LG2 may have a shape in which a sensor-side surface is concave and an object-side surface is convex on the optical axis.

The first lens group LG1 may have positive (+) refractive power. The second lens group LG2 may have a different negative (−) refractive power than the first lens group LG1. The first lens group LG1 and the second lens group LG2 have different focal lengths and opposite refractive powers, thereby providing good optical performance at the center and periphery portions of the FOV. The refractive power is the reciprocal of the focal length.

When expressed as an absolute value, the focal length of the second lens group LG2 may be greater than that of the first lens group LG1. For example, the absolute value of the focal length F_LG2 of the second lens group LG2 may be 1.1 times or more, for example, in the range of 1.1 to 4 times the absolute value of the focal length F_LG1 of the first lens group LG1. Accordingly, the optical system 1000 according to the embodiment may have improved aberration control characteristics such as chromatic aberration and distortion aberration by controlling the refractive power and focal length of each lens group, and good optical performance in the center and periphery portions of the FOV.

In the optical axis OA, the first lens group LG1 and the second lens group LG2 may have a set distance. The optical axis distance between the first lens group LG1 and the second lens group LG2 on the optical axis OA is a separation distance on the optical axis OA, and may be an optical axis distance between the sensor-side surface of the lens closest to the sensor side among the lenses in the first lens group LG1 and the object-side surface of the lens closest to the object side among the lenses in the second lens group LG2.

The optical axis distance between the first lens group LG1 and the second lens group LG2 is greater than the center thickness of the last lens of the first lens group LG1 and may be greater than the center thickness of the first lens of the second lens group LG2. The optical axis distance between the first lens group LG1 and the second lens group LG2 is less than the optical axis distance of the first lens group LG1 and may be 35% or less of the optical axis distance of the first lens group LG1, for example, in the range of 12% to 35% or 17% to 32% of the optical axis distance of the first lens group LG1. Here, the optical axis distance of the first lens group LG1 is the optical axis distance between the object-side surface of the lens closest to the object side in the first lens group LG1 and the sensor-side surface of the lens closest to the sensor side in the first lens group LG1.

The optical axis distance between the first lens group LG1 and the second lens group LG2 may be 11% or more of the optical axis distance of the second lens group LG2, for example, in the range of 11% to 25% or 11% to 20%. The optical axis distance of the second lens group LG2 is the optical axis distance between the object-side surface of the lens closest to the object side in the second lens group LG2 and the sensor-side surface of the lens closest to the sensor side in the second lens group LG2.

Here, when the optical axis distance of the first lens group LG1 is D_LG1, the optical axis distance of the second lens group LG2 is D_LG2, and the total number of lenses is n (n=9, 10, or 11), the following Equation may satisfy: 0<D_LG1/n<0.3 and 0.3<D_LG2/n<0.7.

In addition, when the optical axis distance from the object-side surface of the first lens to the sensor-side surface of the last n-th lens is TD, the following Equation may satisfy: 0.5<TD/n<1. When the sum of the effective diameters from the object-side surface of the first lens to the sensor-side surface of the last n-th lens is ΣCA, the following Equation may satisfy: 7<ΣCA/n<17. In addition, when the sum of the center thicknesses from the first lens to the last lens is ΣCT, the following Equation may satisfy: 0.2<ΣCT/n<0.7, and when the sum of the center distances between two adjacent lenses is ΣCG, the following Equation may satisfy: 0.1<ΣCG<0.4, and may satisfy the relationship: ΣCG<ΣCT. The n is the total number of lenses. Accordingly, a slim optical system may be provided.

A lens having the smallest effective diameter in the first lens group LG1 may be a lens closest to the second lens group LG2. A lens having the smallest effective diameter in the second lens group LG2 may be a lens closest to the first lens group LG1. Here, the size of the effective diameter of each lens is an average value of the effective diameter of the object-side surface and the effective diameter of the sensor-side surface of each lens. Accordingly, the optical system 1000 may have good optical performance not only at the center portion of a field of view (FOV) but also at the periphery portion, and chromatic aberration and distortion aberration may be improved. A size of a lens having a minimum effective diameter in the first lens group LG1 may be smaller than a size of a lens having a minimum effective diameter in the second lens group LG2. Accordingly, a slim telephoto camera module may be provided.

The effective diameter of each lens of the first lens group LG1, that is, the average effective diameter of the object-side surface and the sensor-side surface gradually decreases in the direction from the object side to the sensor side, and the effective diameter of each lens of the second lens group LG2 may gradually increase in the direction from the object side to the sensor side.

Each of the plurality of lenses 100 may include an effective region and a non-effective region. The effective region may be a region through which light incident to each of the lenses 100 passes. That is, the effective region may be an effective region or an effective diameter region in which optical properties are implemented by refracting incident light. The non-effective region may be arranged around the effective region. The non-effective region may be a region in which effective light from the plurality of lenses 100 is not incident. That is, the non-effective region may be a region unrelated to the optical characteristics. Also, an end of the non-effective region may be a region fixed to a barrel (not shown) accommodating the lens.

A lens closest to the object side in the first lens group LG1 may have positive (+) refractive power, and a lens closest to the sensor side in the second lens group LG2 may have negative (−) refractive power. In the optical system 1000, the number of lenses having positive (+) refractive power may be greater than the number of lenses having negative (−) refractive power. In the first lens group LG1, the number of lenses having positive (+) refractive power may be greater than the number of lenses having negative (−) refractive power. In the second lens group LG2, the number of lenses having positive (+) refractive power may be equal to the number of lenses having negative (−) refractive power.

The optical system 1000 may include the image sensor 300 on the sensor side of the lens units 100, 100A, 100B, and 100C. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS). The diagonal length of the image sensor 300 may be greater than 2 mm, for example greater than 4 mm and less than 12 mm. Preferably, ImgH of the image sensor 300 may have a relationship: TTL>ImgH.

The optical system 1000 may include an optical filter 500. The optical filter 500 may be disposed between the second lens group LG2 and the image sensor 300. The optical filter 500 may be disposed between a lens closest to a sensor side among the plurality of lens portions 100, 100A, 100B and 100C and the image sensor 300. For example, when the optical system 100 has 11 lenses, the optical filter 500 may be disposed between the 11th lens 111 and the image sensor 300.

The optical filter 500 may include an infrared filter. The optical filter 500 may pass light of a set wavelength band and filter light of a different wavelength band. When the optical filter 500 includes an infrared filter, radiant heat emitted from external light may be blocked from being transferred to the image sensor 300. In addition, the optical filter 500 can transmit visible light and reflect infrared light. As another example, a cover glass may be further disposed between the optical filter 500 and the image sensor 300.

The optical system 1000 according to the embodiment may include an aperture stop ST. The aperture stop ST may control the amount of light incident on the optical system 1000. The aperture stop ST may be disposed around at least one lens of the first lens group LG1. For example, the aperture stop ST may be disposed around an object-side surface or a sensor-side surface of the second lens 102. The aperture stop ST may be disposed between two adjacent lenses 101 and 102 among the lenses in the first lens group LG1. Alternatively, at least one lens selected from among the plurality of lenses 100 may serve as an aperture stop. In detail, an object-side surface or a sensor-side surface of one lens selected from among the lenses of the first lens group LG1 may serve as an aperture stop for adjusting the amount of light.

The straight-line distance from the aperture stop ST to the sensor-side surface of the n-th lens may be smaller than the optical axis distance TD between the object-side surface of the first lens 101 and the sensor-side surface of the n-th lens. When SD is the optical axis distance from the aperture stop ST to the sensor-side surface of the n-th lens, and the following relationship may satisfy: SD<TD and SD<EFL. In addition, the relationship may satisfy: SD<ImgH. EFL is the effective focal length of the entire optical system and may be defined as F. The relationship may satisfy: EFL>ImgH, and they may have a difference of 2 mm or less. The FOV of the optical system 1000 may be less than 120 degrees, for example, more than 70 degrees and less than 100 degrees. F number (F #) of the optical system 1000 may be greater than 1 and less than 10, for example, in the range of 1.1≤F #≤5, and the entrance pupil size (EPD) may be larger than F #. Accordingly, the optical system 1000 has a slim size, may control incident light, and may have improved optical characteristics within the FOV.

The effective diameter of the lenses gradually decreases from the object-side lens to the lens surface (e.g., the fourth surface) where the aperture stop is disposed, and may gradually increase from the effective diameter of the lens surface (e.g., the fifth surface) disposed on the sensor side of the aperture stop to the effective diameter the lens surface of the last lens.

The optical system 1000 according to the embodiment may further include a reflective member (not shown) for changing a path of light. The reflective member may be implemented as a prism that reflects incident light of the first lens group LG1 toward the lenses. As another example, when the optical axis of the second lens group LG2 and the center of the image sensor are disposed on different axes, the reflective member may be disposed on the emission side of the second lens group LG2. Hereinafter, an optical system according to an embodiment will be described in detail.

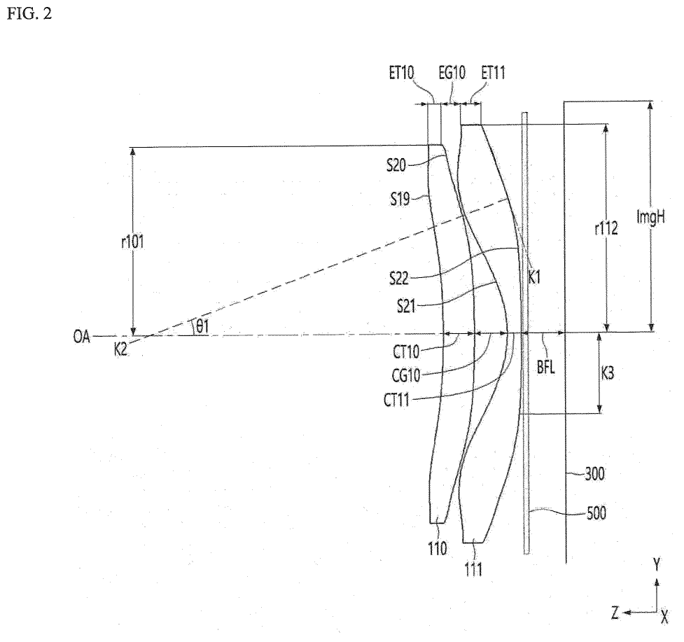

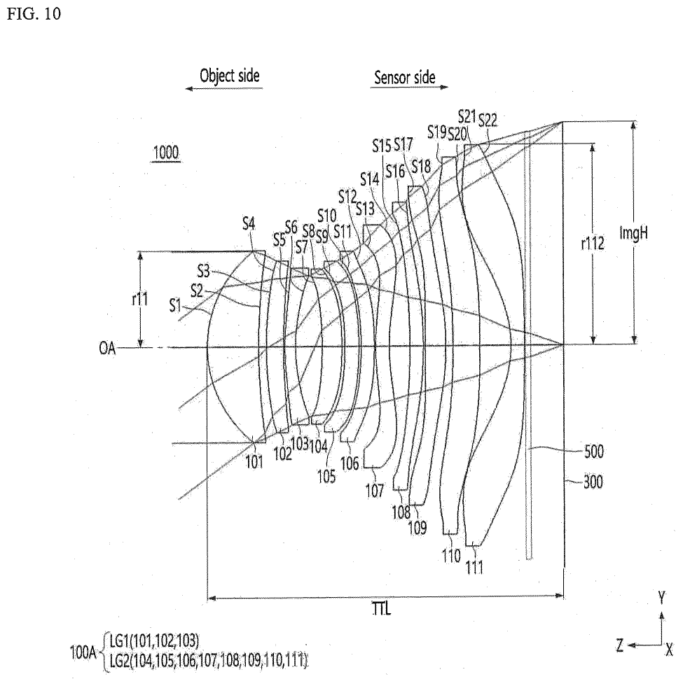

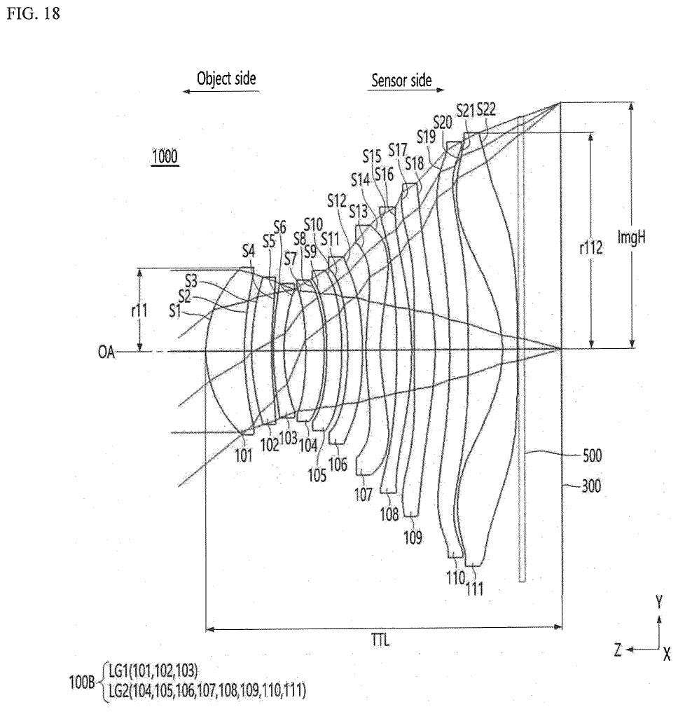

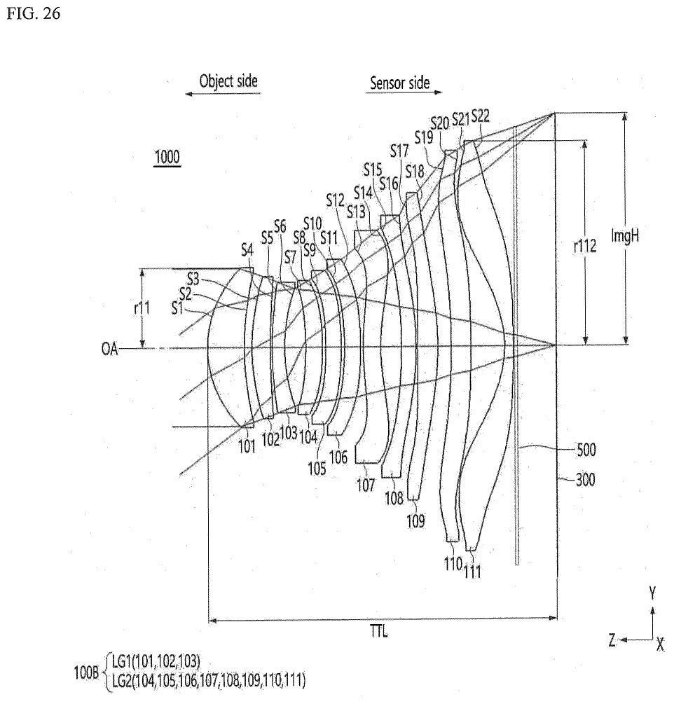

FIG. 1 is a configuration diagram of an optical system and a camera module according to a first embodiment of the invention, FIG. 2 is a diagram illustrating the relationship between an image sensor, an n-th lens, and an n−1th lens of the optical system of FIG. 1, and FIG. 10 is a configuration diagram of an optical system and a camera module according to a second embodiment, FIG. 18 is a configuration diagram of an optical system and a camera module according to a third embodiment, and FIG. 26 is a configuration diagram of an optical system and a camera module according to a fourth embodiment am.

Referring to FIGS. 1, 2, 10, 18, and 26, an optical system 1000 according to embodiments includes lens portions 100, 100A, 100B, and 100C having a plurality of lenses, and the lens portions 100 and 100A, 100B, and 100C may include the first lens 101 to the eleventh lens 111. The first to eleventh lenses 101 to 111 may be sequentially aligned along the optical axis OA of the optical system 1000. Light corresponding to object information may pass through the first to eleventh lenses 111 and the optical filter 500 and be incident on the image sensor 300.

The first lens group LG1 may include the first to third lenses 101-103, and the second lens group LG2 may include the fourth to eleventh lenses 104-111. The optical axis distance between the third lens 103 and the fourth lens 104 may be the optical axis distance between the first and second lens groups LG1 and LG2. The first lens 101 may be the first lens of the optical system, and the eleventh lens 111 may be the last lens.

The number of lenses having a meniscus shape convex from the optical axis to the object side among the first to eleventh lenses 101 to 111 may be 4 or more, and may be in the range of 40% to 50% of the total number of lenses. Among the first to eleventh lenses 101-111, the number of lenses having a meniscus shape convex from the optical axis toward the sensor side may be greater than the number of lenses having a meniscus shape convex toward the object side, and may be 5 or more, for example, in the range from 50% to 60% of the total number of lenses. Accordingly, the meniscus shape convex from the optical axis toward the object side or the sensor side may account for 70% or more of the total number of lenses.

The curvature radius of each lens 101 to 103 of the first lens group LG1 may be a positive value, and the curvature radius of each lens 104 to 110 of the second lens group LG2 is a negative value. The number of lens surfaces with a positive value may be greater than the number of lens surfaces with a positive value.

The first lens 101 may have negative (−) or positive (+) refractive power on the optical axis OA, and may preferably have positive (+) refractive power. The first lens 101 may include a plastic or glass material. For example, the first lens 101 may be made of a plastic material.

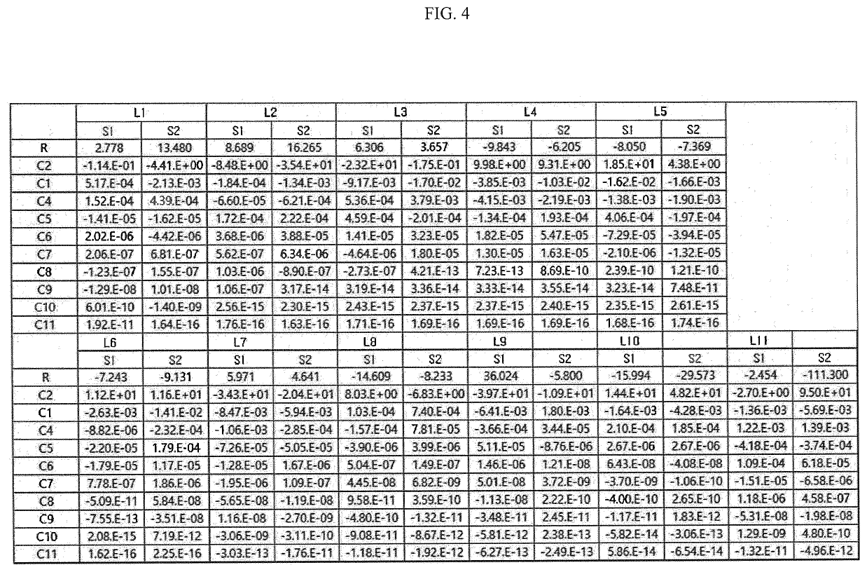

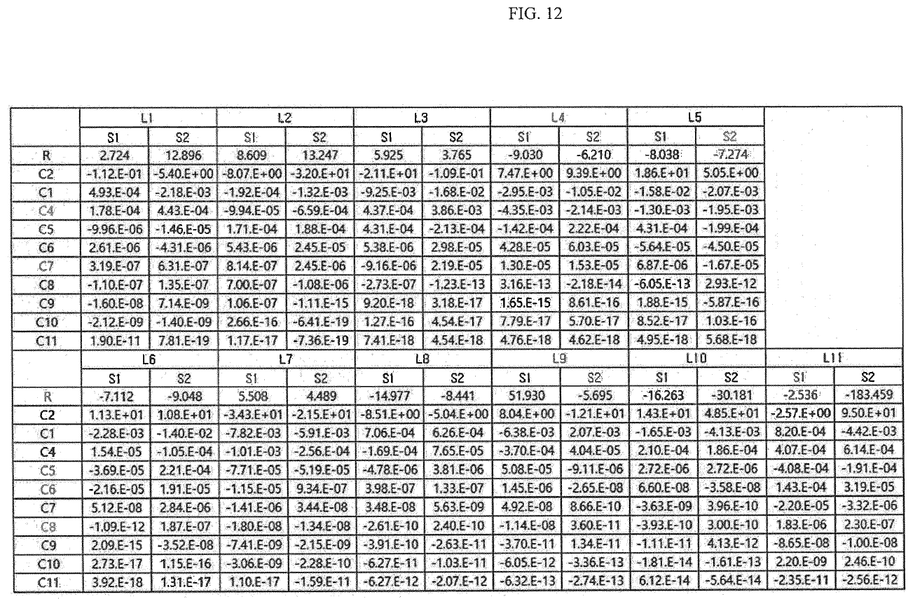

The first lens 101 may include a first surface S1 defined as an object-side surface and a second surface S2 defined as a sensor-side surface. On the optical axis OA, the first surface S1 may have a convex shape, and the second surface S2 may have a concave shape. That is, the first lens 101 may have a meniscus shape convex from the optical axis OA toward the object side. At least one of the first surface S1 and the second surface S2 may be an aspherical surface. For example, both the first surface S1 and the second surface S2 may be aspherical. The aspheric coefficients of the first and second surfaces S1 and S2 are provided as shown in FIGS. 4, 12, 20 and 28, L1 is the first lens 101, L1S1 is the first surface, and L1S2 is the second surface.

The second lens 102 may have positive (+) or negative (−) refractive power on the optical axis OA. The second lens 102 may have positive (+) refractive power. The second lens 102 may include a plastic or glass material. For example, the second lens 102 may be made of a plastic material.

The second lens 102 may include a third surface S3 defined as an object-side surface and a fourth surface S4 defined as a sensor-side surface. On the optical axis OA, the third surface S3 may have a convex shape, and the fourth surface S4 may have a concave shape. That is, the second lens 102 may have a meniscus shape convex from the optical axis OA toward the object side. Alternatively, on the optical axis OA, the third surface S3 may have a convex shape, and the fourth surface S4 may have a convex shape. At least one of the third and fourth surfaces S3 and S4 may be an aspherical surface. For example, both the third surface S3 and the fourth surface S4 may be aspheric surfaces. The aspheric coefficients of the third and fourth surfaces S3 and S4 are provided as shown in FIGS. 4, 12, 20 and 28, L2 is the second lens 102, L2S1 is the third surface, and L2S2 is the fourth surface.

The third lens 103 may have positive (+) or negative (−) refractive power on the optical axis OA, and may preferably have negative (−) refractive power. The third lens 103 may include a plastic or glass material. For example, the third lens 103 may be made of a plastic material.

The third lens 103 may include a fifth surface S5 defined as an object-side surface and a sixth surface S6 defined as a sensor-side surface. On the optical axis OA, the fifth surface S5 may have a convex shape, and the sixth surface S6 may have a concave shape. That is, the third lens 103 may have a meniscus shape convex from the optical axis OA toward the object side. Alternatively, on the optical axis OA, the fifth surface S5 may have a convex shape, and the sixth surface S6 may have a convex shape. At least one of the fifth surface S5 and the sixth surface S6 may be an aspheric surface. For example, both the fifth surface S5 and the sixth surface S6 may be aspheric surfaces. The aspherical coefficients of the fifth and sixth surfaces S5 and S6 are provided as shown in FIGS. 4, 12, 20 and 28, L3 is the third lens 103, L3S1 is the fifth surface, and L3S2 is the sixth surface.

The first lens group LG1 may include the first to third lenses 101, 102, and 103. Among the first to third lenses 101, 102, and 103, the first lens 101 or the second lens 102 may have the thickest thickness in the optical axis OA, that is, the center thickness of the lens, and the third lens 103 may be the thinnest. Accordingly, the optical system 1000 may control incident light and may have improved aberration characteristics and resolution.

Among the first to third lenses 101, 102, and 103, the effective diameter CA (clear aperture) of the lens may be the smallest and the first lens 101 may be the largest. In detail, among the first to third lenses 101, 102, and 103, the size of the effective radius (Semi-aperture) r11 of the first surface S1 may be the largest, and the size of the effective radius of the sixth surface S6 of the third lens 103 may be the smallest. An effective diameter of the second lens 102 may be smaller than that of the first lens 101 and larger than that of the third lens 103. The size of the effective diameter of the third lens 103 may be the smallest among all lenses of the optical system 1000. The size of the effective diameter is an average value of the size of the effective diameter on the object-side surface of each lens and the effective diameter size on the sensor-side surface of each lens. Accordingly, the optical system 1000 may have improved chromatic aberration control characteristics, and may improve vignetting characteristics of the optical system 1000 by controlling incident light.

The refractive index of the third lens 102 may be greater than the refractive index of at least one or both of the first and second lenses 101 and 102. The refractive index of the third lens 103 may be greater than 1.60, for example, 1.65 or greater, and the refractive index of the first and second lenses 101 and 102 may be less than 1.60. The third lens 103 may have an Abbe number smaller than the Abbe numbers of at least one or both of the first and second lenses 101 and 102. For example, the Abbe number of the third lens 103 may be 20 or more smaller than the Abbe number of the first and second lenses 101 and 102, and may be less than 30, for example. In detail, the Abbe number of the first and second lenses 101 and 102 may be 30 or more greater than the Abbe number of the third lens 103. Accordingly, the optical system 1000 may have improved chromatic aberration control characteristics.

When the curvature radius on the optical axis OA is expressed as an absolute value, the curvature radius of the fourth surface S4 of the second lens 102 may be the largest among the first to third lenses 101, 102, and 103. The curvature radius of the first surface S1 of the first lens 101 may be the smallest. In the first lens group LG1, a difference between a lens surface having a maximum curvature radius and a lens surface having a minimum curvature radius may be three times or more. An average curvature radius of the first to sixth surfaces S1 to S6 may be 10 mm or less, for example, in the range of 3 mm to 10 mm. Each of the first to third lenses 101 to 103 may have a meniscus shape convex toward the object side.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be made of a plastic material.

The fourth lens 104 may include a seventh surface S7 defined as an object-side surface and an eighth surface S8 defined as a sensor-side surface. On the optical axis OA, the seventh surface S7 may have a concave shape, and the eighth surface S8 may have a convex shape. That is, the fourth lens 104 may have a meniscus shape convex from the optical axis OA toward the sensor. Alternatively, the fourth lens 104 may have a convex shape on both sides of the optical axis. Alternatively, the fourth lens 104 may have a concave shape on both sides of the optical axis OA. At least one of the seventh surface S7 and the eighth surface S8 may be an aspherical surface. For example, both the seventh surface S7 and the eighth surface S8 may be aspheric surfaces. The aspheric coefficients of the seventh and eighth surfaces S7 and S8 are provided as shown in FIGS. 4, 12, 20 and 28, L4 is the fourth lens 104, L4S1 is the seventh surface, and L4S2 is the eighth surface.

The fifth lens 105 may have positive (+) or negative (−) refractive power on the optical axis OA. The fifth lens 105 may have positive (+) refractive power. The fifth lens 105 may include a plastic or glass material. For example, the fifth lens 105 may be made of a plastic material.

When an absolute value is expressed, the focal length of the fifth lens 105 may be the largest in the optical system, and for example, the following Equation may satisfy: F6<F4<F5, and F5 may be 90 mm or more. Also, the following Equation may satisfy: F4<(F5/2). Here, F4 is the focal length of the fourth lens 104, and F6 is the focal length of the sixth lens 106. Here, the position of the lens having the largest focal length in the optical system may be located at the n−6th position from the last lens, and n is the total number of lenses.

The fifth lens 105 may include a ninth surface S9 defined as an object-side surface and a tenth surface S10 defined as a sensor-side surface. On the optical axis OA, the ninth surface S9 may have a concave shape, and the tenth surface S10 may have a convex shape. That is, the fifth lens 105 may have a meniscus shape convex from the optical axis OA toward the sensor side. Alternatively, the ninth surface S9 of the optical axis OA may have a concave shape, and the tenth surface S10 may have a concave shape. The fifth lens may have a convex shape on both sides. Alternatively, the fifth lens may have a convex shape on both sides. The ninth and tenth surfaces S9 and S10 of the fifth lens 105 may be provided from the optical axis OA to the end of the effective region without a critical point.

At least one of the ninth surface S9 and the tenth surface S10 may be an aspherical surface. For example, both the ninth surface S9 and the tenth surface S10 may be aspheric surfaces. The aspheric coefficients of the ninth and tenth surfaces S9 and S10 are provided as shown in FIGS. 4, 12, 20 and 28, L5 is the fifth lens 105, L5S9 is the ninth surface, and L5S2 is the tenth surface.

The sixth lens 106 may have positive (+) or negative (−) refractive power along the optical axis OA. The sixth lens 106 may have negative (−) refractive power. The sixth lens 106 may include a plastic or glass material. For example, the sixth lens 106 may be made of a plastic material.

The sixth lens 106 may include an eleventh surface S11 defined as an object-side surface and a twelfth surface S12 defined as a sensor-side surface. On the optical axis OA, the eleventh surface S11 may have a concave shape, and the twelfth surface S12 may have a convex shape. That is, the sixth lens 106 may have a meniscus shape convex from the optical axis OA toward the sensor. Alternatively, the sixth lens 106 may have a shape in which both sides are concave or both sides are convex on the optical axis OA. Alternatively, the sixth lens 106 may have a meniscus shape convex toward the object side.

At least one of the eleventh surface S11 and the twelfth surface S12 of the sixth lens 106 may be an aspherical surface. For example, both the eleventh surface S11 and the twelfth surface S12 may be aspherical surfaces. The aspheric coefficients of the eleventh and 12th surfaces S11 and S12 are provided as shown in FIGS. 4, 12, 20 and 28, L6 is the sixth lens 106, L6S1 is the eleventh surface, and L6S2 is the twelfth surface.

The seventh lens 107 may have positive (+) or negative (−) refractive power on the optical axis OA. The seventh lens 107 may have negative (−) refractive power. The seventh lens 107 may include a plastic or glass material. For example, the seventh lens 107 may be made of a plastic material.

The seventh lens 107 may include a thirteenth surface S13 defined as an object-side surface and a fourteenth surface S14 defined as a sensor-side surface. On the optical axis OA, the thirteenth surface S13 may have a convex shape, and the fourteenth surface S14 may have a concave shape. That is, the seventh lens 107 may have a meniscus shape convex from the optical axis OA toward the object side. Alternatively, the seventh lens 107 may have a shape in which both sides are concave or both sides are convex on the optical axis OA. Alternatively, the sixth lens 107 may have a meniscus shape convex toward the sensor.

At least one of the thirteenth surface S13 and the fourteenth surface S14 of the seventh lens 107 may be an aspherical surface. For example, both the thirteenth surface S13 and the fourteenth surface S14 may be aspheric surfaces. The aspheric coefficients of the thirteenth and fourteenth surfaces S13 and S14 are provided as shown in FIGS. 4, 12, 20 and 28, L7 is the seventh lens 107, L7S1 is the thirteenth surface, and L7S2 is the fourteenth surface.

At least one or both of the thirteenth surface S13 and the fourteenth surface S14 of the seventh lens 107 may have a critical point. For example, the thirteenth surface S13 may have at least one critical point from the optical axis OA to the end of the effective region. The fourteenth surface S14 may have at least one critical point from the optical axis to the end of the effective region. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface decreases as it increases, or a point where the slope value increases as it decreases.

The eighth lens 108 may have positive (+) or negative (−) refractive power on the optical axis OA. The eighth lens 108 may have positive (+) refractive power. The eighth lens 108 may include a plastic or glass material. For example, the eighth lens 108 may be made of a plastic material.

The eighth lens 108 may include a fifteenth surface S15 defined as an object-side surface and a sixteenth surface S16 defined as a sensor-side surface. On the optical axis OA, the fifteenth surface S15 may have a concave shape, and the sixteenth surface S16 may have a convex shape. That is, the eighth lens 108 may have a meniscus shape convex from the optical axis OA toward the sensor. Alternatively, the eighth lens 108 may have a concave or convex shape on both sides. Alternatively, the eighth lens 108 may have a meniscus shape convex toward the object side. At least one or both of the fifteenth surface S15 and the sixteenth surface S16 of the eighth lens 108 may be provided without a critical point.

At least one of the fifteenth surface S15 and the sixteenth surface S16 of the eighth lens 107 may be an aspherical surface. For example, both the fifteenth surface S15 and the sixteenth surface S16 may be aspheric surfaces. The aspheric coefficients of the fifteenth and sixteenth surfaces S15 and S16 are provided as shown in FIGS. 4, 12, 20 and 28, L8 is the eighth lens 108, L8S1 is the fifteenth surface, and L8S2 is the sixteenth surface.

The ninth lens 109 may have positive (+) or negative (−) refractive power on the optical axis OA. The ninth lens 109 may have positive (+) refractive power. The ninth lens 109 may include a plastic or glass material. For example, the ninth lens 109 may be made of a plastic material.

The ninth lens 109 may include a seventeenth surface S17 defined as an object-side surface and an eighteenth surface S18 defined as a sensor-side surface. On the optical axis OA, the seventeenth surface S17 may have a convex shape, and the eighteenth surface S18 may have a convex shape. That is, the ninth lens 109 may have a convex shape on both sides of the optical axis OA. Alternatively, the ninth lens 109 may have a meniscus shape with both sides concave or convex toward the sensor. At least one or both of the seventeenth surface S17 and the eighteenth surface S18 of the ninth lens 109 may be provided without a critical point.

At least one of the seventeenth surface S17 and the eighteenth surface S18 of the ninth lens 109 may be an aspheric surface. For example, both the seventeenth surface S17 and the eighteenth surface S18 may be aspheric surfaces. The aspheric coefficients of the seventeenth and eighteenth surfaces S17 and S18 are provided as shown in FIGS. 4, 12, 20 and 28, L9 is the ninth lens 109, L9S1 is the seventeenth surface, and L9S2 is the eighteenth surface.

The tenth lens 110 may have negative (−) refractive power on the optical axis OA. The tenth lens 110 may include a plastic or glass material. For example, the tenth lens 110 may be made of a plastic material.

The tenth lens 110 may include a nineteenth surface S19 defined as an object-side surface and a twentieth surface S20 defined as a sensor-side surface. On the optical axis OA, the nineteenth surface S19 may have a concave shape, and the twentieth surface S20 may have a convex shape. That is, the tenth lens 110 may have a meniscus shape convex from the optical axis OA toward the sensor. Alternatively, the tenth lens 110 may have a concave or convex shape on both sides of the optical axis OA, or may have a meniscus shape convex toward the object side.

At least one or both of the nineteenth surface S19 and the twentieth surface S20 of the tenth lens 110 may have a critical point. The critical point of the nineteenth surface S19 or the twentieth surface S20 may be located at an end of the effective region, that is, a region closer to the edge than the optical axis.

At least one of the nineteenth surface S19 and the twentieth surface S20 of the tenth lens 110 may be an aspherical surface. For example, both the nineteenth surface S19 and the twentieth surface S20 may be aspherical surfaces. The aspheric coefficients of the nineteenth and twentieth surfaces S19 and S20 are provided as shown in FIGS. 4, 12, 20 and 28, L10 is the tenth lens 110, L10S1 is the nineteenth surface, and L10S2 is the twentieth surface.

The eleventh lens 111 may have negative (−) refractive power on the optical axis OA. The eleventh lens 111 may include a plastic or glass material. For example, the eleventh lens 111 may be made of a plastic material. The eleventh lens 111 may be a lens closest to the sensor or the last lens in the optical system 1000.

The eleventh lens 111 may include a twenty-first surface S21 defined as an object-side surface and a twenty-second surface S22 defined as a sensor-side surface. On the optical axis OA, the twenty-first surface S21 may have a concave shape, and the twenty-second surface S22 may have a convex shape. That is, the eleventh lens 111 may have a meniscus shape convex from the optical axis OA toward the sensor side. Alternatively, the eleventh lens 111 may have a convex meniscus shape from the optical axis OA toward the object side, or may have a concave shape or a convex shape on both sides.

The twenty-first surface S21 of the eleventh lens 111 may have a critical point, and the critical point may be located at a region closer to the edge of the effective region than to the optical axis. The twentieth surface S20 of the eleventh lens 111 may be provided without a critical point from the optical axis OA to the end of the effective region. That is, the distance between the twentieth surface S20 and a straight line orthogonal to the optical axis passing through the center may gradually increase from the center toward the edge.

At least one surface of the twenty-first surface S21 and the twenty-second surface S22 of the eleventh lens 111 may be an aspherical surface. For example, both the twenty-first surface S21 and the twenty-second surface S22 may be aspherical surfaces. The aspheric coefficients of the twenty-first and twenty-second surfaces S21 and S22 are provided as shown in FIGS. 4, 12, 20 and 28, L11 is the eleventh lens 111, L11S1 is the twenty-first surface, and L11S2 is the twenty-second surface.

Among the fourth to tenth lenses 104 to 110, the lens having the maximum center thickness is the ninth lens 109, and the center thickness of the ninth lens 109 may be greater than an optical axis distance between the sixth and seventh lenses 106 and 107, and for example, may be 0.6 mm or more. The lens having the minimum center thickness in the second lens group LG2 may be any one of the fourth to eighth lenses 104 to 108 and may be a lens having a center thickness of less than 0.5 mm or less than 0.4 mm. Accordingly, the optical system 1000 may control incident light and may have improved aberration characteristics and resolution. A lens having a maximum center thickness in the optical system may be the ninth lens 109, and a lens having a minimum center thickness may be the third lens 103. A difference between the maximum thickness and the minimum thickness within the optical system may be less than 5 times or less than 4 times. Accordingly, the optical system 1000 having 9 or more lenses may be provided in a slim size.

Among the fourth to eleventh lenses 104-111, the fourth lens 104 may have the smallest average effective diameter CA of the lenses, and the eleventh lens 111 may have the largest average effective diameter. In detail, in the second lens group LG2, the size of the effective diameter of the seventh surface S7 of the fourth lens 104 may be the smallest, and the size of the effective diameter of the twenty-second surface S22 may be the largest. The effective diameter of the twenty-second surface S22 may be the maximum effective diameter in the optical system. Since the size of the effective diameter of the eleventh lens 111 is maximized, the light is refracted in a direction of the optical axis through the first lens group LG1 and light may be refracted to the periphery of the image sensor 300 by the second lens group LG2. Accordingly, the optical system 1000 may have improved chromatic aberration control characteristics, and may improve vignetting characteristics of the optical system 1000 by controlling incident light.

In the second lens group LG2, the number of lenses having a refractive index greater than 1.6 may be greater than the number of lenses having a refractive index less than 1.6. In the second lens group LG2, the number of lenses having an Abbe number greater than 50 may be smaller than the number of lenses having an Abbe number less than 50.

Meanwhile, in the first to third embodiments, the length of ImgH of the image sensor 300 may be 6 mm or less, and in the fourth embodiment, the length of ImgH of the image sensor 300 may be greater than 6 mm. In the first to third embodiments, TTL of the optical system may be 10 mm or less, and in the fourth embodiment, TTL may be greater than 10 mm. TTL of the third embodiment may be less than 8 mm. The second embodiment may have a lower F number than the first, third, and fourth embodiments, and may be less than 1.7.

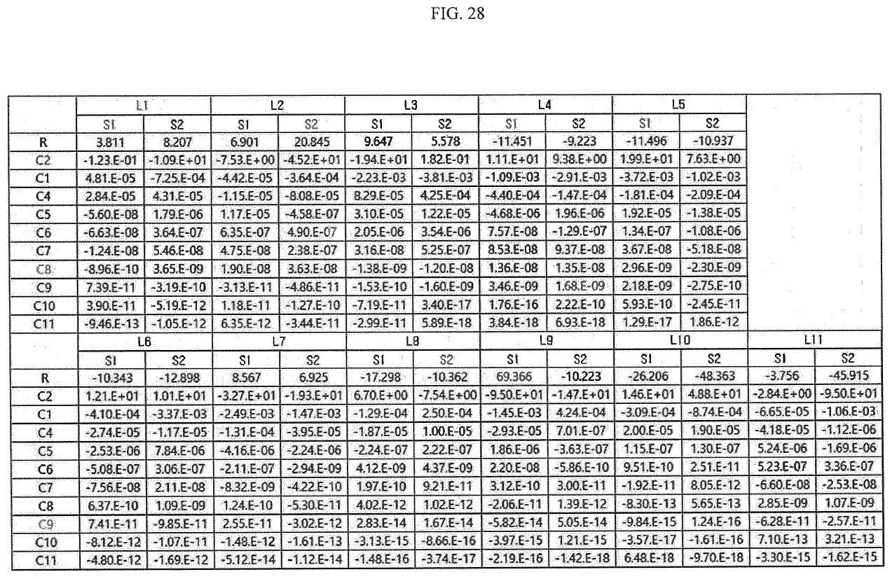

In the first and tenth embodiments of FIGS. 1 and 10, the critical point of the nineteenth surface S19 of the tenth lens 110 may be located at a position of 70% or more of the effective radius from the optical axis OA, for example, in the range of 70% to 94%. In the first to third embodiments of FIGS. 1, 10 and 18, the critical point of the nineteenth surface S19 of the tenth lens 110 may be at a position of 80% or more of the effective radius, for example, in the range of 80% to 94% from the optical axis OA. Alternatively, the critical point of the nineteenth surface S19 of the tenth lens 110 may be located at a distance of 3 mm or more, for example, in a range of 3 mm to 3.8 mm from the optical axis OA. Referring to the fourth embodiment of FIG. 28, when the effective radius may be greater than 5 mm or greater than 6 mm, the critical point of the nineteenth surface S19 may be located at 4.5 mm or more, for example, in the range of 4.5 mm to 5.5 mm from the optical axis OA.

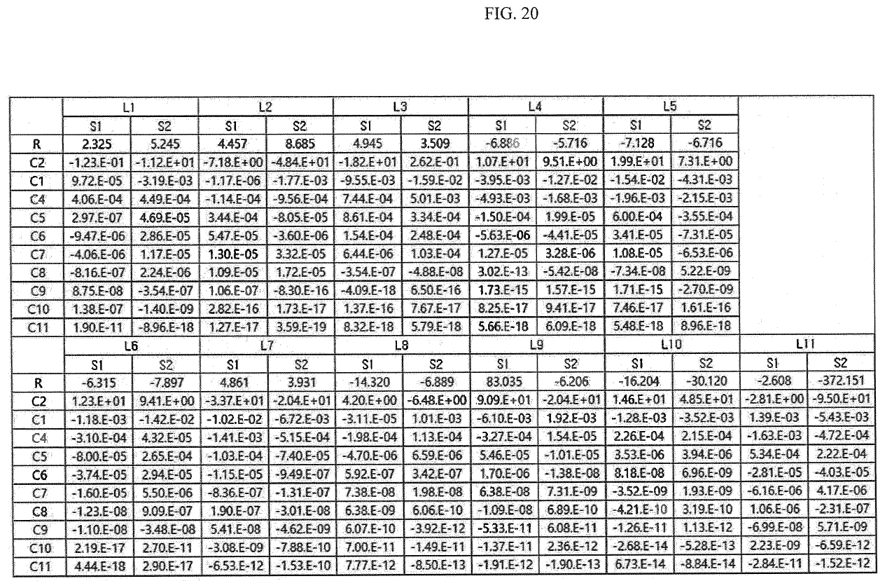

The twentieth surface S20 of the tenth lens 110 may have no critical point from the optical axis OA to the end of the effective region. In the embodiments of FIGS. 20 and 28, the critical point of the twentieth surface S20 may be located at a position of 80% or more of the effective radius, for example, in a range of 80% to 92% from the optical axis. In an embodiment, the critical point of the twenty-first surface S21 of the eleventh lens 111 may be disposed at a position of 60% or more of the effective radius or a position within a range of 70% to 85% from the optical axis OA.

Referring to the embodiments of FIGS. 1, 10 and 18, when the effective radius of the twenty-first surface S21 is less than 5 mm, the critical point of the twenty-first surface S21 may be located at 3 mm or more, for example, in the range of 3 mm to 3.8 mm from the optical axis OA. Referring to the embodiment of FIG. 28, when the effective radius is greater than 5 mm or greater than 6 mm, the critical point of the twenty-first surface S21 may be located at 4.5 mm or more, for example, in the range of 4.5 mm to 5.5 mm from the optical axis OA.

In FIG. 2, the twenty-second surface S22 of the eleventh lens 111 may be provided without a critical point from the optical axis OA to the end of the effective region. Here, the effective radius r112 of the twenty-second surface S22 is a distance from the optical axis OA to the end of the effective region, and a first distance K3 may define a distance at which a height from a straight line orthogonal to the optical axis OA and passing through the center of the twenty-second surface S22 to the lens surface is less than 0.1 mm, or a point at which the slope angle of a tangent passing through the twenty-second surface S22 is less than 10 degrees. When the maximum distance from the optical axis to the point where the height from the lens surface is less than 0.1 mm is the first distance K3, the first distance K3 may be located at 20% or more of the effective radius r112, for example, in the range of 20% to 55%.

When the effective radius r112 of the twenty-second surface S22 of the eleventh lens 111 is less than 5 mm, in the embodiments of FIGS. 1, 10 and 18, the first distance K3 may be located at 53% or less of the effective radius r112, for example, in the range of 43% to 53%, or preferably, it may be located at a distance of 2.4 mm or less, for example, in the range of 1.8 mm to 2.4 mm from the optical axis OA. When the effective radius r112 of the twenty-second surface S22 is greater than 5 mm or greater than 6 mm, in the embodiment of FIG. 26, the first distance K3 may be located at 39% or less of the effective radius r112, for example, in the range of 20% to 39%, or preferably, it may be located at a distance of 3 mm or less, for example, in the range of 2 mm to 3 mm from the optical axis OA.

In addition, in FIG. 2, a distance from the eleventh lens 111 to a point where the slope angle of the tangent passing through the twenty-second surface S22 is less than 10 degrees may be defined as the first distance K3. in the embodiments of FIGS. 1, 10 and 18, when the effective radius r112 of the twenty-second surface S22 is less than 5 mm, the first distance K3 may be located at 53% or less of the effective radius r112, for example, in the range of 43% to 53%, or preferably, it may be located at a distance of 2.4 mm or less from the optical axis OA, for example, in the range of 1.8 mm to 2.4 mm. When the effective radius r112 of the twenty-second surface S22 is greater than 5 mm or greater than 6 mm, in the embodiment of FIG. 26, the first distance K3 may be located at 50% or less of the effective radius r112, for example, in the range of 35% to 50%, or preferably, it may be located at a distance of 3.5 mm or less, for example, 2.5 mm to 3.5 mm from the optical axis OA.

Since the twenty-second surface S22 of the eleventh lens 111 is provided without a critical point, the center of the twenty-second surface S22 may be positioned closest to the image sensor 300. Accordingly, it may not be necessary to increase the distance between the eleventh lens 111 and the image sensor 300, thereby preventing an increase in the TTL of the optical system.

In detail, it is preferable that the eleventh lens 111 of the optical system 1000 satisfies the aforementioned range for controlling optical characteristics such as chromatic aberration, distortion characteristics, aberration characteristics, and resolving power. Accordingly, the path of light emitted to the image sensor 300 through the lens may be effectively controlled. Therefore, the optical system 1000 according to the embodiment may have improved optical characteristics even in the center and periphery portions of the field of view (FOV).

As shown in FIG. 2, the normal line K2, which is a straight line perpendicular to the tangent line K1 passing through an arbitrary point on the sensor-side twenty-second surface S22 of the eleventh lens 111, which is the last lens, may have a predetermined angle θ1 from the optical axis OA, and the maximum angle of the angle θ1 may be greater than 5 degrees and less than 45 degrees. Accordingly, since the optical axis or paraxial region of the twentieth surface S20 has a minimum Sag value, a slim optical system may be provided.

A back focal length (BFL) is an optical axis distance from the image sensor 300 to the last lens. That is, BFL is a distance in the optical axis between the image sensor 300 and the sensor-side twenty-second surface S22 of the eleventh lens 111. CT10 is the center thickness or optical axis thickness of the tenth lens 110, and L10_ET is the end or edge thickness of the effective region of the tenth lens 110. CT11 is the center thickness or optical axis thickness of the eleventh lens 111. CG10 is an optical axis distance (i.e., center distance) from the center of the sensor-side surface of the tenth lens 110 to the center of the object-side surface of the eleventh lens 111. That is, the optical axis distance CG10 from the center of the sensor-side surface of the tenth lens 110 to the center of the object-side surface of the eleventh lens 111 is a distance between the twentieth surface S20 and the twenty-first surface S21 in the optical axis OA. In this form, the center thickness of each of the first to eleventh lenses 101 to 111 may be represented by CT1 to CT11, and the thickness of the edge, which is the end of the effective region, may be represented by ET1 to ET11.

In addition, the center distance between the first and second lenses 101 and 102 is CG1, the center distance between the second and third lenses 102 and 103 is CG2, and the center distance between the third and fourth lenses 103 and 104 is CG3. The center distance between the fourth and fifth lenses 104 and 105 is CG4, the center distance between the fifth and sixth lenses 105 and 106 is CG5, the center distance between the sixth and seventh lenses 106 and 107 is CG6, the center distance between the seventh and eighth lenses 107 and 108 is CG7, the center distance between the eighth and ninth lenses 108 and 109 is CG8, the center distance between the ninth and tenth lenses 109 and 110 is CG9, and the center distance between the tenth and eleventh lenses 110 and 111 may be defined as CG10. The edge distances between the two adjacent lenses may be represented by EG1 to EG10.

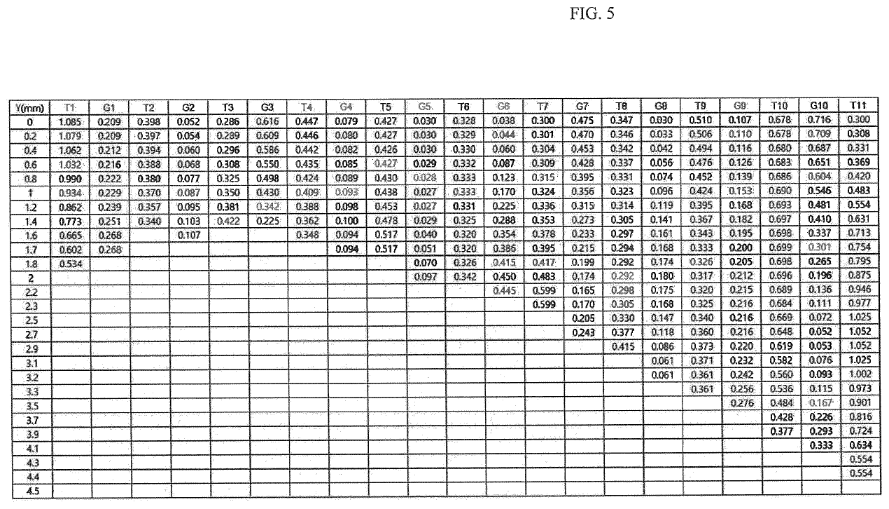

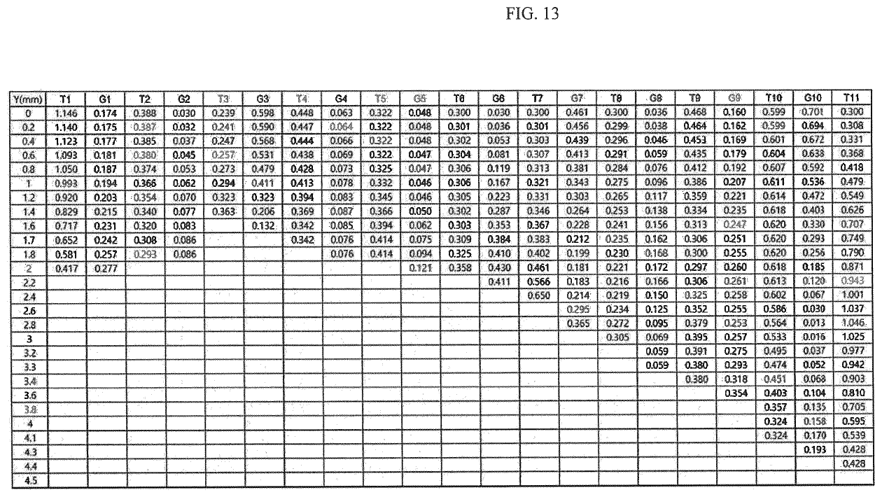

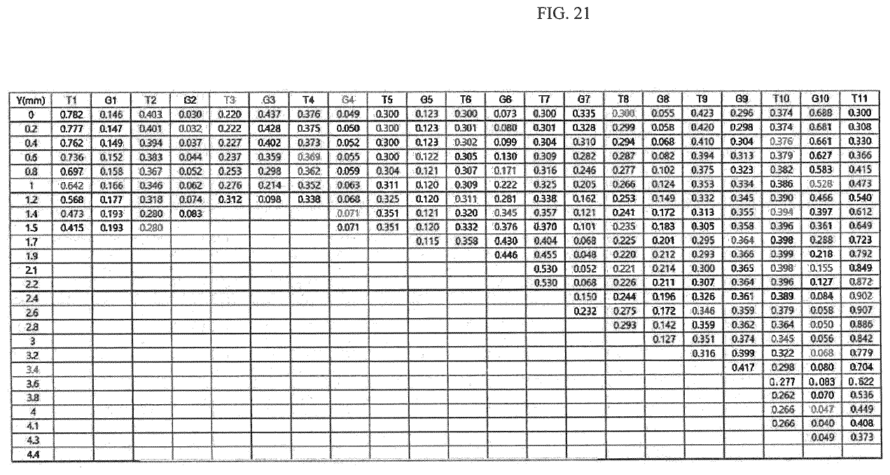

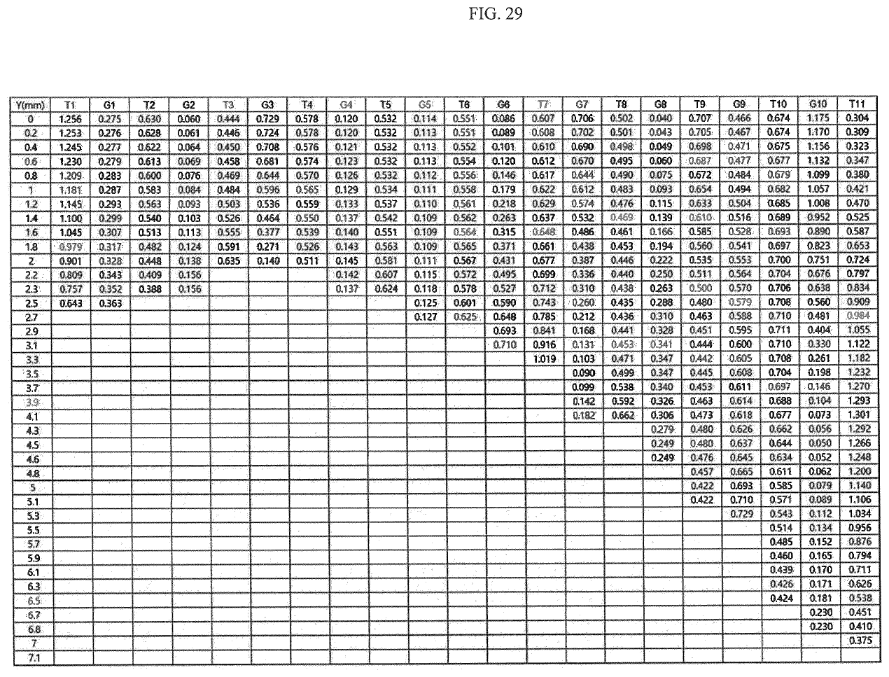

As shown in FIGS. 5, 13, 21, and 29, the thickness of each lens 101 to 111 is indicated by T1 to T11, and may be indicated at distances of 0.1 mm or more along the first direction Y with respect to the optical axis. In addition, the distances between two adjacent lenses may be represented by G1 to G10, and may be represented as an distance of 0.1 mm or more from the center between the two adjacent lenses toward the first direction Y.

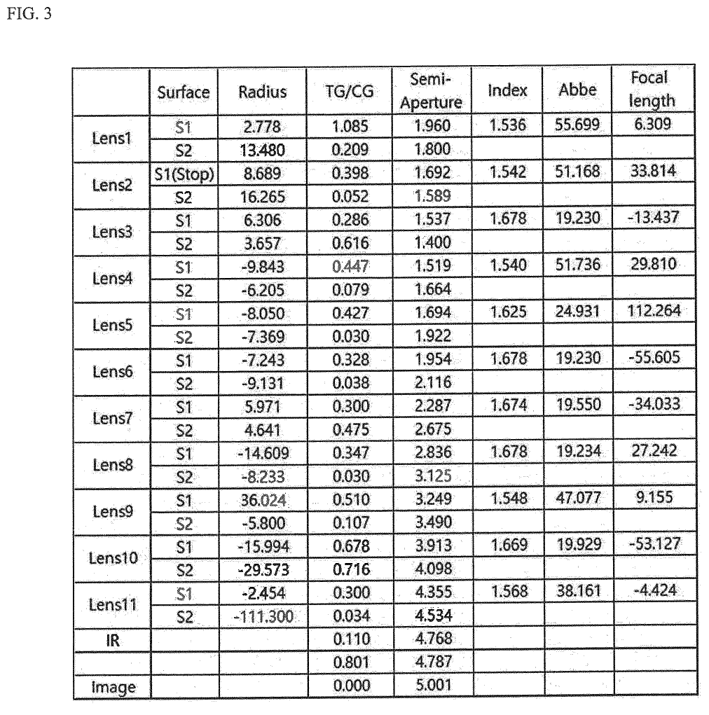

As shown in FIGS. 3, 11, 19 and 27, the distance CG10 between the tenth and eleventh lenses 110 and 111 may be greater than the center distance CG3 between the third and fourth lenses 103 and 104, the following relationship may satisfy: CG3<CG10, and CG10 may be 0.5 mm or more. Among the center distances CG1 to CG10 between two adjacent lenses, the distance CG10 between the tenth and eleventh lenses 110 and 111 may be the largest, and the center distance CG3 between the third and fourth lenses 103 and 104 may be the second largest.

In the center thickness of the lenses, the center thickness CT1 of the first lens 101 is the largest among the center thicknesses of the lenses, and may be greater than the center distance CG10 between the tenth lens 110 and the eleventh lens 111. The center thickness CT3 of the third lens 103 is the smallest among the center thicknesses of the lenses, and may be smaller than the center distance CG4 between the third lens 103 and the fourth lens 104.

Here, when the sum of the center thicknesses of three lenses having a thickness greater than the center thickness of the other lenses is CTabc, and the sum of the center distances of three distances greater than the center distance between adjacent lenses is CGabc, the following relationship may satisfy: CTabc>CGabc. CTabc*n may be greater than or equal to 15 mm, for example, in the range of 15 mm to 30 mm, CTabc*n may be greater than or equal to 14 mm, for example, in the range of 14 mm to 28 mm, and n is the number of lenses. Accordingly, the optical system 1000 having 10 or more lenses may be provided in a slim size. Within the specification, * denotes multiplication.

The number of lenses of 1.6 or more in the optical system 1000 may be 50% or more of the total number of lenses. When the number of lenses equal to or greater than 1.6 is Na, the following relationship may satisfy: Na*n>55, where n is the number of lenses.

The overall refractive index average may be greater than or equal to 1.55, such as greater than or equal to 1.58. The overall Abbe number average may be 40 or less, such as 35 or less. The sum of the center thicknesses of each lens may be greater than or equal to 3.5 mm, for example, in the range of 3.5 mm to 7.5 mm. Preferably, the first to third embodiments may be less than 6 mm, for example, in the range of 3.5 mm to 5.5 mm, and the fourth embodiment may be greater than 6 mm, for example, in the range of 6.1 mm to 7.5 mm.

The sum of center distances between adjacent lenses may be less than or equal to 4.2 mm, for example, in the range of 2 mm to 4.2 mm. Preferably, the sum of the center distances of the first to third embodiments may be in the range of 2 mm to 3 mm, and the sum of the center distances in the fourth embodiment may be in the range of 3 mm to 4.2 mm. A slim optical system having such center thickness and center distance may be provided.

Describing the curvature radius as an absolute value, at least one or both of the seventeenth surface S17 of the ninth lens 109 or the twenty-second surface S22 of the eleventh lens 111 among the lens portions 100, 100A, 100B, and 100C may be greater than the curvature radius of the other lens surface. Preferably, in the first to third embodiments, the curvature radius of the twenty-second surface S22 of the eleventh lens 111 may be the largest among the lens surfaces. In the fourth embodiment, the curvature radius of the seventeenth surface S17 of the ninth lens 109 may be the largest among lens surfaces.

Describing the focal length as an absolute value, the focal length of the fifth lens 105 among the lens portions 100, 100A, 100B, and 100C may be the maximum among the lenses, and the focal length of the eleventh lens 111 may be the minimum among the lenses. The maximum focal distance may be 15 times or more of the minimum focal distance.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the field of view (FOV) but also in the periphery portion. The optical system 1000 may have improved resolving power and may have a slimmer and more compact structure.

Hereinafter, the center thicknesses of the first to eleventh lenses 101 to 111 may be defined as CT1 to CT11, the edge thicknesses may be defined as ET1 to ET11, and the center distances or optical axis distances between two adjacent lenses may be defined as CG1 through CG10, and the edge distances between two adjacent lenses may be defined as EG1 through EG10. The unit of the thickness and distance is mm.

$$2 < CT 3 / CT 1 < 7 \qquad [ Equation 1 ]$$

In Equation 1, when the thickness CT3 of the third lens 103 in the optical axis and the thickness CT1 of the first lens 101 in the optical axis are satisfied, the optical system 1000 may improve the aberration characteristics. Preferably, Equation 1 may satisfy: 2<CT3/CT1<5.

$$0.3 < CT 3 / ET 3 < 2 \qquad [ Equation 2 ]$$

In Equation 2, when the thickness CT3 of the optical axis of the third lens 103 and the edge thickness ET3 of the third lens 103 are satisfied, the optical system 1000 may have improved chromatic aberration control characteristics. Preferably, Equation 2 may satisfy: 0.3<CT3/ET3<1.

$$1 < CT 1 / ET 1 < 5 \qquad [ Equation 2 - 1 ]$$

$$1 < CT 2 / ET 2 < 5 \qquad [ Equation 2 - 2 ]$$

$$( CT 2 + C T 3 ) < CT 1 \qquad [ Equation 2 - 3 ]$$

$$0.8 < CT 4 / ET 4 < 3 \qquad [ Equation 2 - 4 ]$$

$$0.8 \leq CT 5 / ET 5 < 3 \qquad [ Equation 2 - 5 ]$$

$$0.7 < CT 6 / ET 6 < 3 \qquad [ Equation 2 - 6 ]$$

$$0.6 \leq CT 7 / ET 7 < 1.2 \qquad [ Equation 2 - 7 ]$$

$$0.6 < CT 8 / ET 8 < 1.2 \qquad [ Equation 2 - 8 ]$$

$$1 < CT 9 / ET 9 < 3 \qquad [ Equation 2 - 9 ]$$

$$1 < CT 10 / ET 10 < 3 \qquad [ Equation 2 - 10 ]$$

$$0.3 < CT 11 / ET 11 < 1.2 \qquad [ Equation 2 - 11 ]$$

$$0.5 < SD / TD < 1 \qquad [ Equation 2 - 12 ]$$

When the ratio of the center thickness to the edge thickness of the second to eleventh lenses 102 to 111 in Equations 2-1 to 2-12 is satisfied, the optical system 1000 may have improved chromatic aberration control characteristics. SD is the optical axis distance from the aperture stop to the sensor side twenty-second surface S22 of the eleventh lens 111, and TD is the distance from the object-side first surface S1 of the first lens 111 to the sensor-side twenty-second surface S22 of the eleventh lens 111 in the optical axis. The aperture stop may be disposed around a sensor-side surface of the second lens 102. When the optical system 1000 according to the embodiment satisfies Equation 2-12, chromatic aberration of the optical system 1000 may be improved.

$$1 < \vert F\_LG2 / F\_LG1 \vert < 10 \qquad [ Equation 2 - 13 ]$$

F_LG1 is the composite focal length of the first lens group LG1, and F_LG2 is the composite focal length of the second lens group LG2. When the optical system 1000 according to the embodiment satisfies Equation 2-13, chromatic aberration of the optical system 1000 may be improved. That is, as the value of Equation 2-13 approaches 1, the distortion aberration may be reduced. The value of Equation 2-13 may satisfy: 2<|F_LG2/F_LG1|<6.

$$3 < Σ C T - CT\_Aver < 7 \qquad [ Equation 3 ]$$

In Equation 3, ΣCT is the sum of the center thicknesses of all lenses, for example, the sum of the center thicknesses of the first to eleventh lenses. CT_Aver is the average of the center thicknesses of all lenses. When Equation 3 is satisfied, the optical system may improve factors affecting reduction of distortion aberration. Equation 3 may satisfy: 3.5≤ΣCT−CT_Aver≤6.5.

$$1.6 < n 3 \qquad [ Equation 4 ]$$

In Equation 4, n3 means the refractive index of the third lens 103 at the d-line. When the optical system 1000 according to the embodiment satisfies Equation 4, the optical system 1000 may improve chromatic aberration characteristics. Preferably, it may satisfy: 1.65≤n3. Also, it may satisfy: 17<(n3*n) (n is the total number of lenses).

$$16 < n 1 * n < 17 \qquad [ Equation 4 - 1 ]$$

$$16 < n 11 * n < 18$$

In Equation 4-1, n1 means the refractive index of the first lens 101 on the d-line, n11 means the refractive index of the eleventh lens 111 at the d-line, and n is the number of lenses in the optical system. When the optical system 1000 according to the embodiment satisfies Equation 4-1, the effect on the TTL of the optical system 1000 may be suppressed.

$$17 < n 6 * n \\ 16.5 < n 10 * n \qquad [ Equation 4 - 2 ]$$

In Equation 4-2, n6 means the refractive index of the sixth lens 106 at the d-line, n10 means the refractive index of the tenth lens 110 at the d-line, and n is the number of lenses in the optical system. When the optical system 1000 according to the embodiment satisfies Equation 4-2, the optical system 1000 may improve chromatic aberration characteristics.

$$0 \text{.5} < L11S2\_max \_sag to Sensor < 1.5 \qquad [ Equation 5 ]$$

In Equation 5, L11S2_max_sag to Sensor means the distance from the maximum Sag value of the sensor-side twenty-second surface S22 of the eleventh lens 111 to the image sensor 300 in the optical axis direction. For example, L11S2_max_sag to Sensor means the distance from the critical point P2 of the sensor-side surface of the eleventh lens 111 to the image sensor 300 in the optical axis direction. When the optical system 1000 according to the embodiment satisfies Equation 5, the optical system 1000 may secure a space for the optical filter 500 disposed between the lens portions 100, 100A, 100B, and 100C and the image sensor 300, so it may have improved assemblability. In addition, when the optical system 1000 satisfies Equation 5, the optical system 1000 may secure a gap for module manufacturing. Preferably, Equation 5 may satisfy: 0.5<L11S2_max_sag to Sensor<1. Also, L11S2_max_sag to Sensor may be the same as BFL.

In the lens data for the embodiments, the position of the filter 500, in detail, the distance between the last lens and the filter 500, and the distance between the image sensor 300 and the filter 500 are set for convenience in the design of the optical system 1000, and the filter 500 may be freely disposed within a range in which the last lens and the image sensor 300 do not come into contact. Accordingly, the value of L11S2_max_sag to Sensor in the lens data may be equal to the BFL of the optical system 1000, and the position of the filter 500 may move within a range that is not in contact with the last lens and the image sensor 300, respectively, to have good optical performance. That is, the distance between the critical point P2 and the image sensor 300 of the twenty-second surface S22 of the eleventh lens 111 may be the minimum and gradually increase toward the end of the effective region.

$$0.9 < BFL / L11S2\_max \_sag to Sensor < 2 \qquad [ Equation 6 ]$$

In Equation 6, BFL means a distance (mm) in the optical axis OA from the center of the sensor-side twenty-second surface S22 of the eleventh lens 111 closest to the image sensor 300 to the image surface of the image sensor 300. When the optical system 1000 according to the embodiment satisfies Equation 6, the optical system 1000 may improve distortion aberration characteristics and may have good optical performance in the periphery portion of the FOV. Here, the maximum Sag value may be the position of the critical point. Equation 6 may satisfy: 1≤BFL/L11S2_max_sag to Sensor<1.5.

$$5 < \vert L11S2\_max slope \vert < 45 \qquad [ Equation 7 ]$$

In Equation 7, L11S2_max slope means the maximum value (Degree) of the tangential angle measured on the sensor-side twenty-second surface S22 of the eleventh lens 111. In detail, In the twenty-second surface S22, L11S2_max slope means an angle value (Degree) of a point having the largest tangential angle with respect to a virtual line extending in a direction perpendicular to the optical axis OA. When Equation 7 according to the embodiment is satisfied, the optical system 1000 may control the occurrence of lens flare. Preferably, Equation 7 may satisfy: 30≤|L11S2_max slope|<45.

$$- 5 < \vert L11S2\_max slope \vert - \vert L10S2\_max slope \vert < 30 \qquad [ Equation 8 ]$$

In Equation 8, L10S2_max slope means the maximum value (Degree) of the tangential angle measured on the sensor-side twentieth surface S20 of the tenth lens 110. Here, in Equation 8, when the effective radius r112 of the twenty-second surface S22 of the eleventh lens 111 is less than 5 mm, the condition may satisfy: 10<|L11S2_max slope|−|L10S2_max slope|<30. In Equation 8, when the effective radius r112 of the twenty-second surface S22 of the eleventh lens 111 is greater than 5 mm or greater than 6 mm, the condition may satisfy: −5<|L11S2_max slope|−|L10S2_max slope|<5. When Equation 8 is satisfied, the optical system 1000 may control the occurrence of lens flare.

$$10 < CG 10 / G10\_min < 60 \qquad [ Equation 9 ]$$

Equation 9 may set the center distance CG10 and the minimum distance G10_min of the distance G10 between the tenth lens 110 and the eleventh lens 111. When the optical system 1000 according to the embodiment satisfies Equation 9, the optical system 1000 may improve distortion aberration characteristics and may have good optical performance in the periphery portion of the FOV. In the value of Equation 9, the upper limit in the first, third and fourth embodiments is 40 or less, and the lower limit in the second embodiment may be greater than 40.

$$1 < CG 10 / EG 10 < 15 \qquad [ Equation 10 ]$$

In Equation 10, when the optical axis distance CG10 and the edge distance EG10 between the tenth and eleventh lenses 110 and 111 are satisfied, good optical performance may be obtained even in the center and periphery portions of the FOV. In addition, the optical system 1000 may reduce distortion and thus have improved optical performance. In the value of Equation 10, the upper limit in the first, second, and fourth embodiments is 10 or less, and the lower limit in the third embodiment may be greater than 8.

$$0.01 < CG 2 / CG 4 < 1 \qquad [ Equation 11 ]$$

In Equation 11, when the optical axis distance CG2 between the second lens 102 and the third lens 103 and the optical axis distance CG4 between the fourth and fifth lenses 104 and 105 are satisfied, the optical system 1000 may improve aberration characteristics and control the size of the optical system 1000, for example, TTL reduction. Preferably, Equation 11 may satisfy the condition: 0.01<CG2/CG4<0.8 or 0.11<(CG2/CG4)*n<8.8, where n is the number of lenses.

$$3 < CA\_L11S2 / CG 10 < 20 \qquad [ Equation 11 - 1 ]$$

In Equation 11-1, CA_L11S2 is the effective diameter of the largest lens surface, and is the size of the effective diameter of the sensor-side twenty-second surface S22 of the eleventh lens 111. When the optical system 1000 according to the embodiment satisfies Equation 11-1, the optical system 1000 may improve aberration characteristics and control TTL reduction. Preferably, Equation 11-1 may satisfy: 8<CA_L11S2/CG10<15.

$$5 < CA\_L10S2 / CG 10 < 15 \qquad [ Equation 11 - 2 ]$$

Equation 11-2 may set the optical axis distance CG10 between the effective diameter CA_L10S2 of the sensor-side twentieth surface S20 of the tenth lens 110 and the tenth and eleventh lenses 110 and 111. When the optical system 1000 according to the embodiment satisfies Equation 11-2, the optical system 1000 may improve aberration characteristics and control TTL reduction. Preferably, Equation 11-2 may satisfy: 7<CA_L10S2/CG10<15.

$$1 \leq CT 1 / CT 11 < 5 \qquad [ Equation 12 ]$$

When the thickness CT1 of the optical axis of the first lens 101 and the thickness CT11 of the optical axis of the eleventh lens 111 are satisfied in Equation 12, the optical system 1000 may have improved aberration characteristics. In addition, the optical system 1000 has good optical performance at a set FOV and may control TTL. Preferably, Equation 12 may satisfy: 2≤CT1/CT11<5 or 22≤(CT1/CT11)*n<55, where n is the number of lenses.

$$1 < CT 10 / CT 11 < 5 \qquad [ Equation 13 ]$$

In Equation 13, when the thickness CT10 of the tenth lens 110 in the optical axis and the thickness CT11 of the eleventh lens 111 in the optical axis are satisfied, the optical system 1000 determines the tenth lens 110 and manufacturing precision of the eleventh lens 111 may be alleviated, and optical performance of the center and periphery portions of the FOV may be improved. Preferably, Equation 13 may satisfy: 1<CT10/CT11<3 or 11<(CT10/CT11)*n<33, where n is the number of lenses. In the case of the first to third embodiments, the center thickness of the seventh, eighth, and tenth lenses may satisfy the condition: (CT7+CT8)<CT10 or (CT7+CT11)<CG10, and in the case of the fourth embodiment, the condition may satisfy: (CT7+CT11)<CG10.

$$5 < L 10 R 2 / L 11 R 1 < 20 \qquad [ Equation 14 ]$$

In Equation 14, L10R2 means the curvature radius (mm) on the optical axis of the twentieth surface S20 of the tenth lens 110, and L11R1 means the curvature radius on the optical axis of the twenty-first surface S21 of the eleventh lens 111. When the optical system 1000 according to the embodiment satisfies Equation 14, the aberration characteristics of the optical system 1000 may be improved. Preferably, Equation 14 may satisfy the condition: 7<L10R2/L11R1≤15 or 55<(L10R2/L11R1)*n<220, where n is the number of lenses.

$$0 < ( C G 10 - E G 10 ) / ( CG 10 ) < 2 \qquad [ Equation 15 ]$$

When Equation 15 satisfies the center distance CG10 and the edge distance CG11 between the tenth and eleventh lenses 110 and 111, the optical system 1000 may reduce distortion and have improved optical performance. When the optical system 1000 according to the embodiment satisfies Equation 15, the optical performance of the center and periphery portions of the FOV may be improved. Equation 15 may preferably satisfy: 0<(CG10−EG10)/(CG10)<1.

$$1 < CA\_L1S1 / CA\_L3S1 < 2 \qquad [ Equation 16 ]$$

In Equation 16, CA_L1S1 means the effective diameter CA (clear aperture) of the first surface S1 of the first lens 101, and CA_L3S1 means the effective diameter of the fifth surface S5 of the third lens 103. When the optical system 1000 according to the embodiment satisfies Equation 16, the optical system 1000 may control light incident to the first lens group LG1 and may have improved aberration control characteristics. Equation 16 preferably satisfies: 1≤CA_L1S1/CA_L3S1≤1.5 or 11≤(CA_L1S1/CA_L3S1)*n≤17, where n is the number of lenses.

$$1 < CA\_L11S2 / CA\_L4S2 < 5 \qquad [ Equation 17 ]$$

In Equation 17, CA_L4S2 means the effective diameter of the eighth surface S8 of the fourth lens 104, and CA_L11S2 means the effective diameter of the twenty-second surface S22 of the eleventh lens 111. When the optical system 1000 according to the embodiment satisfies Equation 17, the optical system 1000 may control light incident to the second lens group LG2 and improve aberration characteristics. Preferably, Equation 17 may satisfy: 2<CA_L11S2/CA_L4S2<4 or 32<(CA_L11S2/CA_L4S2)*n<44, where n is the number of lenses.

$$0.8 < CA\_L4S2 / CA\_L3S2 < 2 \qquad [ Equation 18 ]$$

In Equation 18, when the effective diameter CA_L3S2 of the sixth surface S6 of the third lens 103 and the effective diameter CA_L4S2 of the eighth surface S8 of the fourth lens 104 are satisfied, the optical system 1000 may improve chromatic aberration by controlling an optical path between the first and second lens groups LG1 and LG2, and may control vignetting for optical performance. Preferably, Equation 18 may satisfy: 1≤CA_L4S2/CA_L3S2<1.5 or 11≤(CA_L4S2/CA_L3S2)*n<15, where n is the number of lenses.

$$0.1 < CA\_L10S2 / CA\_L11S2 \leq 1 \qquad [ Equation 19 ]$$

In Equation 19, when the effective diameter CA_L10S2 of the twentieth surface S20 of the tenth lens 110 and the effective diameter CA_L11S2 of the twenty-second surface S22 of the eleventh lens 111 are satisfied, the optical system 1000 may improve chromatic aberration by controlling the light path on the emission side. Preferably, Equation 19 may satisfy: 0.5≤CA_L10S2/CA_L11S2≤1 or 5.5≤(CA_L10S2/CA_L11S2)*n≤11, where n is the number of lenses.

$$1 < CG 3 / EG 3 < 15 \qquad [ Equation 20 ]$$

In Equation 20, when the center distance CG3 between the third and fourth lenses 103 and 104 and the edge distance EG3 are satisfied, the optical system 1000 may reduce chromatic aberration and improve aberration characteristics and controllable vignetting for optical performance. Preferably, Equation 20 may satisfy: 3<CG3/EG3<13.

$$0 < CG 9 / EG 9 < 1 \qquad [ Equation 21 ]$$

In Equation 21, when the center distance CG9 and the edge distance EG9 between the ninth and tenth lenses 109 and 110 are satisfied, the optical system may have good optical performance in the center and periphery portions of the FOV, distortion occurrence may be prevented. Preferably, Equation 21 may satisfy the condition: 0.2<CG9/EG9<0.6.

At least one of Equations 20 and 21 may further include at least one of Equations 21-1 to 21-6.

$$0 < CG 1 / EG 1 < 1 \qquad [ Equation 22 - 1 ]$$

$$0 < CG 2 / EG 2 < 1 \qquad [ Equation 22 - 2 ]$$

$$0.5 < CG 4 / EG 4 < 2 \qquad [ Equation 22 - 3 ]$$

$$0.5 < CG 5 / EG 5 < 2 \qquad [ Equation 22 - 4 ]$$

$$0.1 < CG 6 / EG 6 < 0.5 \qquad [ Equation 22 - 5 ]$$

$$1 < CG 7 / EG 7 < 10 \qquad [ Equation 22 - 6 ]$$

$$0 < CG 8 / EG 8 < 1 \qquad [ Equation 22 - 7 ]$$

$$1 < CG 10 / EG 10 < 20 \qquad [ Equation 22 - 8 ]$$

$$0.8 < G10\_max / CG 10 < 1.2 \qquad [ Equation 22 ]$$

In Equation 22, when the center distance CG10 and the maximum distance G10_max of the distance between the tenth and eleventh lenses 110 and 111 are satisfied, the optical system 1000 may improve optical performance in the periphery portion of the FOV. And, distortion of the aberration characteristics may be suppressed.

$$0 < CT 10 / CG 10 < 1 \qquad [ Equation 23 ]$$

In Equation 23, when the thickness CT10 of the tenth lens 110 in the optical axis and the distance CG10 between the tenth and eleventh lenses 110 and 111 in the optical axis are satisfied, the optical system 1000 may reduce the size of the effective diameters of the tenth and eleventh lenses and the center distance between adjacent lenses, and improve the optical performance of the periphery portion of the FOV. Preferably, Equation 23 may satisfy: 0.4<CT10/CG10<1 or 4.4<(CT10/CG10)*n<11, where n is the total number of lenses.

$$0.1 < CT 11 / CG 10 < 1 \qquad [ Equation 24 ]$$

In Equation 24, when the thickness CT11 of the eleventh lens 111 on the optical axis and the distance CG10 between the tenth and eleventh lenses 110 and 111 are satisfied, the optical system 1000 may reduce the size of the effective diameter and the distance of the tenth and eleventh lenses, and improve the optical performance of the periphery portion of the FOV. Preferably, Equation 24 may satisfy the condition: 0.1<CT11/CG10<0.5 or 1.1<(CT11/CG10)*n<5.5.

$$( C T 8 + C T 9 + C T 10 ) > ( C G 7 + C G 8 + C G 9 + C G 10 ) \qquad [ Equation 25 ]$$

In Equation 25, when the center thicknesses CT8, CT9 and CT10 of the eighth, ninth, and tenth lenses and the optical axis distances CG7, CG8, CG9, and CG10 between the eighth, ninth, tenth, and eleventh lenses are satisfied, the optical system 1000 may reduce the size of the effective diameters and the distance of the eighth to eleventh lenses, and improve the optical performance of the periphery portion of the FOV.

$$0 < CT 9 / CG 10 < 1 \qquad [ Equation 26 ]$$

When Equation 26 satisfies the thickness CT9 in the optical axis of the ninth lens 109 and the optical axis distance CG10 between the tenth and eleventh lenses, the optical system 1000 may reduce the size of the effective diameter and the center distance of the ninth and tenth lenses, and improve the optical performance of the periphery portion of the FOV. Preferably, Equation 26 may satisfy the condition: 0.5<CT9/CG10<0.9 or 5.5<(CT9/CG10)*n<9.9, where n is the total number of lenses.

$$1 < \vert L 10 R 1 / CT 10 \vert < 50 \qquad [ Equation 27 ]$$

When Equation 27 satisfies the curvature radius L10R1 of the nineteenth surface S19 of the tenth lens and the thickness CT10 of the tenth lens in the optical axis, the optical system 1000 may control the refractive power of the tenth lens and improve the optical performance of light at an exit side of the second lens group LG2. Preferably, Equation 27 may satisfy the following condition: 20<|L10R1/CT10|<50, or 220<(|L10R1/CT10|)*n<550, where n is the total number of lenses.

$$1 < L 10 R 1 / L 11 R 1 < 10 \qquad [ Equation 28 ]$$

When Equation 28 satisfies the curvature radius L10R1 of the nineteenth surface S19 of the tenth lens and the curvature radius L11R1 of the twentieth-first surface S21 of the eleventh lens, the shape and refractive power of the tenth and eleventh lenses may be controlled, optical performance may be improved, and optical performance of the exit side of the second lens group LG2 may be improved. Preferably, Equation 28 may satisfy: 4<L10R1/L11R1<9.

$$0 < L 1 R 1 / L 1 R 2 < 1 \qquad [ Equation 28 - 1 ]$$

$$0 < L 2 R 1 / L 2 R 2 < 1 \qquad [ Equation 28 - 2 ]$$

$$1 < L 3 R 1 / L 3 R 2 < 2 \qquad [ Equation 28 - 3 ]$$

$$1 < L 4 R 1 / L 4 R 2 < 2 \qquad [ Equation 28 - 4 ]$$

$$1 \leq L 5 R 1 / L 5 R 2 < 2 \qquad [ Equation 28 - 5 ]$$

$$0.1 \leq L 6 R 1 / L 6 R 2 < 1 \qquad [ Equation 28 - 6 ]$$

$$1 < L 7 R 1 / L 7 R 2 < 2 \qquad [ Equation 28 - 7 ]$$

$$1 < L 8 R 1 / L 8 R 2 < 2 \qquad [ Equation 28 - 8 ]$$

$$- 30 < L 9 R 1 / L 9 R 2 < 0 \qquad [ Equation 28 - 9 ]$$

$$0 < L 10 R 1 / L 10 R 2 < 1 \qquad [ Equation 28 - 10 ]$$

$$0 < L 11 R 1 / L 11 R 2 < 0.1 \qquad [ Equation 28 - 11 ]$$

Equations 28-1 to 28-11 may set the curvature radii R1 and R2 of the object-side surface and the sensor-side surface of each lens, and when these are satisfied, the lens size and resolving power may be determined. At least one of Equations 27 and 28 may include at least one of Equations 28-1 to 28-11 below, and resolution of each lens may be determined.

$$0 < CT\_Max / CG\_Max < 2 \qquad [ Equation 29 ]$$

In Equation 29, the largest thickness CT_max in the optical axis OA of each of the lenses and the air gap or the maximum value CG_max of the distances in the optical axis between the plurality of lenses is satisfied. In this case, the optical system 1000 has good optical performance at the set FOV and focal length, and the size of the optical system 1000, for example TTL may be reduced. Preferably, Equation 29 satisfies: 1≤CT_Max/CG_Max<2 or 11<(CT_Max/CG_Max)*n<22, where n is the total number of lenses. Also, Equation may satisfy:

$$0.5 < \sum CT / \sum CG < 5 \qquad [ Equation 30 ]$$

In Equation 30, ΣCT means the sum of the thicknesses (mm) in the optical axis OA of each of the plurality of lenses, and ΣCG means the sum of the distances (mm) in the optical axis OA between two adjacent lenses in the plurality of lenses. When the optical system 1000 according to the embodiment satisfies Equation 30, the optical system 1000 has good optical performance at the set FOV and focal length, and may reduce the size of the optical system 1000, for example, TTL. Preferably, Equation 30 may satisfy 1.5≤ΣCT/ΣCG<2.5. Also, 17<(ΣCT/ΣCG)*n<28 may be satisfied, where n is the total number of lenses. Equation may satisfy: ΣCT*n>40, and ΣCG*n>22.

$$10 < Σ Index < 30 \qquad [ Equation 31 ]$$

In Equation 31, ΣIndex means the sum of the refractive indices of each of the plurality of lenses at the d-line. When the optical system 1000 according to the embodiment satisfies Equation 31, TTL of the optical system 1000 may be controlled and resolution may be improved. Here, the average refractive index of the first to eleventh lenses may be greater than 1.55. Preferably, Equation 33 may satisfy: 10<ΣIndex<20 or 110<(ΣIndex)*n<220, where n is the number of lenses.

$$10 < Σ Abb / Σ Index < 50 \qquad [ Equation 32 ]$$

In Equation 32, ΣAbb means the sum of Abbe numbers of each of the plurality of lenses. When the optical system 1000 according to the embodiment satisfies Equation 32, the optical system 1000 may have improved aberration characteristics and resolution. An average Abbe number of the first to eleventh lenses may be 50 or less. Preferably, Equation 32 may satisfy: 10<ΣAbb/ΣIndex<30, or 110<(ΣAbb/ΣIndex)*n<330, where n is the total number of lenses.

$$0 < \vert Max\_distortion \vert < 5 \qquad [ Equation 33 ]$$

In Equation 33, Max_distortion means the maximum value of distortion in a region from the center (0.0F) to the diagonal end (1.0F) based on the optical characteristics detected by the image sensor 300. When the optical system 1000 according to the embodiment satisfies Equation 33, the optical system 1000 may improve distortion characteristics. Preferably, Equation 33 may satisfy: 0.5<|Max_distortion|<3.

$$0 < EG\_Max / CT\_Max < 2 \qquad [ Equation 34 ]$$

In Equation 34, CT_max means the thickest thickness (mm) among the thicknesses on the optical axis OA of each of the plurality of lenses, and EG_Max is the maximum edge-side distance between two adjacent lenses. When the optical system 1000 according to the embodiment satisfies Equation 34, the optical system 1000 has a set FOV and focal length, and may have good optical performance in the periphery portion of the FOV. Preferably, Equation 34 may satisfy the condition: 0<EG_Max/CT_Max<1.

$$0.5 < CA\_L1S1 / CA\_min < 2 \qquad [ Equation 35 ]$$

In Equation 35, when the effective diameter CA_L1S1 of the first surface of the first lens and the smallest effective diameter CA_Min among the effective diameters of the first to twenty-second surfaces S1-S22 is satisfied, it is possible to control light incident through the first lens and provide a slim optical system while controlling light to be emitted and maintaining optical performance. Preferably, Equation 35 may satisfy the condition: 1<CA_L1S1/CA_min<2, or 11<(CA_L1S1/CA_min)*n<22, where n is the total number of lenses.

$$1 < CA\_max / CA\_min < 7 \qquad [ Equation 36 ]$$

In Equation 36, CA_max means the largest effective diameter among the object-side and sensor-side surfaces of the plurality of lenses, and means the largest effective diameter (mm) among the effective diameters of the first to twenty-second surfaces S1-S22. When the optical system 1000 according to the embodiment satisfies Equation 36, the optical system 1000 may provide a slim and compact optical system while maintaining optical performance. Preferably, Equation 36 may satisfy: 3<CA_max/CA_min<5.

$$1 < CA\_max / CA\_Aver < 4 \qquad [ Equation 37 ]$$

In Equation 37, the maximum effective diameter CA_max and the average effective diameter CA_Aver of the object side and the sensor side of the plurality of lenses are set, and when these are satisfied, a slim and compact optical system may be provided. Preferably, Equation 37 may satisfy: 1.5<CA_max/CA_AVR<3.

$$0.1 < CA\_min / CA\_Aver < 1 \qquad [ Equation 38 ]$$

In Equation 38, the smallest effective diameter CA_min and the average effective diameter CA_Aver of the object-side and sensor-side surfaces of the plurality of lenses may be set, and when these are satisfied, a slim and compact optical system may be provided. Preferably, Equation 38 may satisfy: 0.1<CA_min/CA_AVR≤0.8.

$$ΣCA * n > 1000 \qquad [ Equation 39 ]$$

In Equation 39, the total effective diameter according to the number of lenses may be set by multiplying the sum ΣCA of the effective diameters of the object-side and sensor-side surfaces of the plurality of lenses and the total number of lenses. When this is satisfied, a slim and compact optical system may be provided.

$$50 < ( CA\_Max - CA\_Min ) * n > 120 \qquad [ Equation 40 ]$$

In Equation 40, a difference between the maximum effective diameter CA_Max and the minimum effective diameter CA_Min among the effective diameters of the object side and the sensor side of the plurality of lenses and the total number n of lenses may be set. Accordingly, a slim and compact optical system may be provided by setting the maximum difference in the effective diameter according to the number of lenses.

$$0.1 < CA\_max / ( 2 \times ImgH ) < 1.5 \qquad [ Equation 41 ]$$

In Equation 41, the largest effective diameter CA_max among the object-side surfaces and the sensor-side surfaces of the plurality of lenses and the distance ImgH from the center (0.0F) of the image sensor 300 overlapping the optical axis OA of the image sensor 300 to the diagonal end (1.0F) may be set, and when this is satisfied, the optical system 1000 may have good optical performance in the center and periphery portions of the FOV and provide a slim and compact optical system. Here, ImgH*n may range from 44 mm to 110 mm, and n is the total number of lenses. Preferably, Equation 41 may satisfy: 0.5≤CA_max/(2*ImgH)<1.

$$0.1 < TD / CA\_max < 1.5 \qquad [ Equation 42 ]$$

In Equation 42, TD is the maximum optical axis distance (mm) from the object-side surface of the first lens to the sensor-side surface of the last lens. For example, TD is the distance from the first surface S1 of the first lens 101 to the twenty-second surface S22 of the eleventh lens 111 in the optical axis OA. When the optical system 1000 according to the embodiment satisfies Equation 42, a slim and compact optical system may be provided. Preferably, Equation 42 may satisfy: 0.1<TD/CA_max<1.

$$0 < \vert F / L 11 R 2 \vert < 1 \qquad [ Equation 43 ]$$

In Equation 43, the total effective focal length F of the optical system 1000 and the curvature radius L11R2 of the twenty-second surface of the eleventh lens may be set, and when satisfied, a size of the optical system 1000, for example, TTL may be reduced. Preferably, Equation 43 may satisfy: 0<F/L10R2<0.5.

Equation 43 may further include Equation 43-1 below.

$$1 < F / F \# < 6 \qquad [ Equation 43 - 1 ]$$

The F # may mean an F number. Preferably, Equation 43-1 may satisfy 3≤F/F #<6.

$$0 < F / \vert L 10 R 2 \vert < 1 \qquad [ Equation 43 - 2 ]$$

Equation 43-2 may set the total effective focal length F of the optical system 1000 and the curvature radius L10R2 of the twentieth surface of the tenth lens. Preferably, Equation 43-2 may satisfy: 0<F/L10R2<0.5.

$$1 < F / L 1 R 1 < 10 \qquad [ Equation 44 ]$$

In Equation 44, the curvature radius L1R1 and the total effective focal length F of the first surface S1 of the first lens 101 may be set, and when they are satisfied, the optical system 1000 may be reduced in size, and for example, TTL may be reduced. Preferably, Equation 44 may satisfy the condition: 1<F/L1R1<5 or 11<(F/L1R1)*n<55, where n is the total number of lenses.

$$0 < \vert EPD / L 11 R 2 \vert < 2 \qquad [ Equation 45 ]$$

In Equation 45, EPD means the entrance pupil diameter (mm) of the optical system 1000, and L11R2 means the curvature radius (mm) of the twenty-second surface S22 of the eleventh lens 111. When the optical system 1000 according to the embodiment satisfies Equation 45, the optical system 1000 may control overall brightness and may have good optical performance in the center and periphery portions of the FOV. Preferably, Equation 45 may satisfy the following condition: 0<|EPD/L11R2|<0.5.

Equation 45 may further include Equation 45-1 below.

$$1 < EPD / F \# < 3 \qquad [ Equation 45 - 1 ]$$

$$0.5 < EPD / L 1 R 1 < 8 \qquad [ Equation 46 ]$$

Equation 46 represents the relationship between the size of the entrance pupil of the optical system and the curvature radius of the first surface S1 of the first lens 101, and may control incident light. Preferably, Equation 46 may satisfy: 0.5<EPD/L1R1<2.

$$- 3 < F 1 / F 3 < 0 \qquad [ Equation 47 ]$$

In Equation 47, the focal distances F1 and F3 of the first and third lenses 101 and 103 may be set. Accordingly, resolving power may be improved by adjusting the refractive power of the incident light of the first and second lenses 101 and 102, and TTL may be controlled. Preferably, Equation 47 may satisfy: −1<F1/F3<0.

$$1 < F 13 / F < 5 \qquad [ Equation 48 ]$$

In Equation 48, when the composite focal length F13 of the first to third lenses and the total focal length F may set, the optical system 1000 may improve resolving power by adjusting the refractive power of incident light, and the optical system 1000 may control the TTL. Preferably, Equation 48 may satisfy: 1≤F13/F<3.

$$1 < \vert F 411 / F 13 \vert < 10 \qquad [ Equation 49 ]$$

In Equation 49, the composite focal length F13 of the first to third lenses, that is, the focal length mm of the first lens group, and the composite focal length F411 of the fourth to eleventh lenses, that is, the focal length of the second lens group may be set, and when this is satisfied, resolving power may be improved by controlling the refractive power of the first lens group and the refractive power of the second lens group, and the optical system may be provided in a slim and compact size. In addition, when Equation 49 is satisfied, the optical system 1000 may improve aberration characteristics such as chromatic aberration and distortion aberration. Equation 49 may preferably satisfy: 1<|F411/F13|<2. Here, it may satisfy: F13>0 and F411<0.

Equation 49 may satisfy at least one of 49-1 to 49-10.

$$0 < F 1 / F < 2 \qquad [ Equation 49 - 1 ]$$

$$1 < F 2 / F < 10 \qquad [ Equation 49 - 2 ]$$

$$- 7 < F 3 / F < 0 \qquad [ Equation 49 - 3 ]$$

$$1 < F 4 / F < 15 \qquad [ Equation 49 - 4 ]$$

$$10 < F 5 / F < 30 \qquad [ Equation 49 - 5 ]$$

$$F 6 < 0 \qquad [ Equation 49 - 6 ]$$

$$F 7 < 0 \qquad [ Equation 49 - 7 ]$$

$$0 < F 8 / F < 10 \qquad [ Equation 49 - 8 ]$$

$$0 < F 9 / F < 10 \qquad [ Equation 49 - 9 ]$$

$$- 20 < F 10 / F < 0 \qquad [ Equation 49 - 10 ]$$

$$- 2 < F 11 / F < 0 \qquad [ Equation 49 - 11 ]$$

$$1.1 < F 3 / F 2 \qquad [ Equation 49 - 12 ]$$

In Equations 49-1 to 49-12, the focal length F1-F11 of each lens and the total focal length F may be set, and when these are satisfied, the resolving power may be improved by controlling the refractive power of each lens, and the optical system may be provided in a slim and compact size.

$$2 mm < TTL < 20 mm \qquad [ Equation 50 ]$$

In Equation 50, TTL means the distance (mm) in the optical axis OA from the apex of the first surface S1 of the first lens 101 to the image surface of the image sensor 300. Preferably, Equation 50 may satisfy: 5 mm<TTL<15 mm or 55<TTL*n<165, where n is the total number of lenses. Accordingly, a slim and compact optical system may be provided.

$$2 mm < ImgH \qquad [ Equation 51 ]$$

Equation 51 sets the diagonal size (2*ImgH) of the image sensor 300 to exceed 4 mm, thereby providing an optical system with high resolution. Equation 51 preferably satisfies: 4 mm≤ImgH<12 mm or 40≤ImgH*n<120, where n is the total number of lenses.

$$BFL < 2.5 mm \qquad [ Equation 52 ]$$

Equation 52 may secure an installation space of the filter 500 by making the BFL of less than 2.5 mm, improve assembly of components, and improve coupling reliability through the distance between the image sensor 300 and the last lens. Equation 52 may preferably satisfy: 0<BFL<1.2 mm.

$$2 mm < F < 20 mm \qquad [ Equation 53 ]$$

In Equation 53, the total focal length F may be set according to the optical system, and it may preferably satisfy: 5 mm<F<15 mm or 55<F*n<167, where n is the total number of lenses.

$$FOV < 120 degrees \qquad [ Equation 54 ]$$

In Equation 54, FOV means a field of view of the optical system 1000, and may provide an optical system of less than 120 degrees. FOV may be greater than 70 degrees, for example, in the range of 70 degrees to 110 degrees.

$$0.5 < TTL / CA\_max < 2 \qquad [ Equation 55 ]$$

In Equation 55, a slim and compact optical system may be provided by setting the largest effective diameter CA_max among the object side and sensor side of the plurality of lenses and TTL. Preferably, Equation 55 may satisfy: 0.5<TTL/CA_max<1.

$$0.5 < TTL / ImgH < 3 \qquad [ Equation 56 ]$$

Equation 56 may set the TTL of the optical system and the diagonal length (ImgH) from the optical axis of the image sensor 300. When the optical system 1000 according to the embodiment satisfies Equation 56, the optical system 1000 may have a smaller TTL by securing a BFL for applying a relatively large image sensor 300, for example, a large image sensor 300 of around 1 inch, and may have a high-definition implementation and a slim structure. Preferably, Equation 56 may satisfy: 1<TTL/ImgH<2.

$$0.01 < BFL / ImgH < 0.5 \qquad [ Equation 57 ]$$

Equation 57 may set the distance between the optical axis between the image sensor 300 and the last lens and the length in the diagonal direction from the optical axis of the image sensor 300. When the optical system 1000 according to the embodiment satisfies Equation 57, the optical system 1000 may secure a BFL for applying a relatively large image sensor 300, for example, a large image sensor 300 of around 1 inch, and minimize the distance between the last lens and the image sensor 300, thereby having good optical characteristics at the center and periphery portion of the FOV. Preferably, Equation 57 may satisfy: 0.1≤BFL/ImgH≤0.3.

$$5 < TTL / BFL < 15 \qquad [ Equation 58 ]$$

Equation 58 may set (unit, mm) the total optical axis length TTL of the optical system and the optical axis distance BFL between the image sensor 300 and the last lens. When the optical system 1000 according to the embodiment satisfies Equation 58, the optical system 1000 secures the BFL and may be provided slim and compact. Equation 58 may satisfy: 6<TTL/BFL<10.

$$0.5 < F / TTL < 1.5 \qquad [ Equation 59 ]$$

Equation 59 may set the total focal length F and total optical axis length TTL of the optical system 1000. Accordingly, a slim and compact optical system may be provided. Equation 59 may preferably satisfy: 0.5<F/TTL<1.

$$0 < F \# / TTL < 0.5 \qquad [ Equation 59 - 1 ]$$

Equation 59-1 may set the F number (F #) and the total optical axis length TTL of the optical system 1000. Accordingly, a slim and compact optical system may be provided.

$$3 < F / BFL < 10 \qquad [ Equation 60 ]$$

Equation 60 may set (unit: mm) the total focal length F of the optical system 1000 and the optical axis distance BFL between the image sensor 300 and the last lens. When the optical system 1000 according to the embodiment satisfies Equation 64, the optical system 1000 may have a set FOV, may have an appropriate focal length, and may provide a slim and compact optical system. In addition, the optical system 1000 may minimize the distance between the last lens and the image sensor 300, so that it may have good optical characteristics in the periphery portion of the FOV. Preferably, Equation 60 may satisfy: 5<F/BFL<9.

$$0.5 < F / ImgH < 3 \qquad [ Equation 61 ]$$

Equation 61 may set the total focal length F (mm) of the optical system 1000 and the diagonal length (ImgH) from the optical axis in the image sensor 300. The optical system 1000 may have improved aberration characteristics by applying a relatively large image sensor 300, for example, a large image sensor 300 of around 1 inch. Preferably, Equation 61 may satisfy: 1≤F/ImgH<2.

$$1 < F / EPD < 5 \qquad [ Equation 62 ]$$

Equation 62 may set the total focal length F (mm) of the optical system 1000 and the entrance pupil diameter. Accordingly, the overall brightness of the optical system may be controlled. Preferably, Equation 62 may satisfy: 1.5≤F/EPD<3.

$$0 < BFL / TD < 0.3 \qquad [ Equation 63 ]$$

In Equation 63, the optical axis distance BFL between the image sensor 300 and the last lens and the optical axis distance TD of the lenses are set, and when these are satisfied, the optical system 1000 may provide a slim and compact optical system. Preferably, Equation 63 may satisfy: 0<BFL/TD≤0.2. When BFL/TD exceeds 0.3, the size of the entire optical system increases because the BFL compared to TD is designed to be large, which makes it difficult to miniaturize the optical system, and since the distance between the eleventh lens and the image sensor increases, the amount of unnecessary light may increase through the eleventh lens and the image sensor, and as a result, there is problem in that resolving power is lowed, such as deterioration in aberration characteristics.

$$0 < EPD / ImgH / FOV < 0.2 \qquad [ Equation 64 ]$$

In Equation 64, the relationship between the size of the EPD, the length ImgH of ½ of the maximum diagonal length of the image sensor, and the FOV may be set. Accordingly, the overall size and brightness of the optical system may be controlled. Equation 64 may preferably satisfy: 0<EPD/ImgH/FOV<0.1.

$$10 < FOV / F \# < 70 \qquad [ Equation 65 ]$$

Equation 65 may set the relationship between the FOV of the optical system and the F number. Equation 65 may preferably satisfy: 30<FOV/F #<60.

$$0 < n 1 / n 2 < 1.5 \qquad [ Equation 66 ]$$

When the refractive indices n1 and n2 of the first and second lenses 101 and 102 of Equation 66 at the d-line satisfy the above range, the optical system may improve the resolution of the incident light. Preferably, it may satisfy: 0.5<n1/n2<1.2.

$$0 < n 3 / n 4 < 1.5 \qquad [ Equation 67 ]$$

When the refractive indices n3 and n4 of the first and third lenses 101 and 103 in Equation 67 satisfy the above range, the optical system may improve resolution of the incident light of the second lens group LG2. Preferably, Equation 67 may satisfy: 1<n3/n4<1.2.

$$2 \leq ( CA\_L11S2 / CA\_L3S2 ) / ( CA\_L1S1 / CA\_L3S2 ) < 5 \qquad [ Equation 68 ]$$

Equation 68 sets the minimum effective diameter (CA_L3S2) and the maximum effective diameter (CA_L11S2) of the lenses, and effective diameters (CA_L1S1, CA_L3S2) on both sides of the first lens group to effectively guide incident light and control chromatic aberration.

$$13 < ( TTL / ImgH ) * n < 23 \qquad [ Equation 69 ]$$

In Equation 69, the relationship between the total number (n) of lenses for TTL and ImgH may be set. When Equation 69 is satisfied, the length and overall length of the image sensor may be controlled.

$$21 < ( TD\_LG2 / TD\_LG1 ) * n < 31 \qquad [ Equation 70 ]$$

In Equation 70, the optical axis distance of the first lens group LG1 and the optical axis distance of the second lens group LG2 may be set. Here, TD_LG1 is the optical axis distance from the first surface S1 to the sixth surface S6, and TD_LG2 is the optical axis distance from the seventh surface S7 to the twenty-second surface S22. When Equation 70 satisfies the above condition, chromatic aberration of the optical system may be improved.

$$5 < ( CT\_Max + CG\_Max ) * n < 12 \qquad [ Equation 71 ]$$

In Equation 71, the maximum center thickness CT_Max and the minimum center distance CG_Max for the total number (n) of lenses may be set, and when these are satisfied, aberration characteristics may be improved and the size of the optical system may be reduced.

$$40 < ( FOV * TTL ) / n < 85 \qquad [ Equation 72 ]$$

In Equation 72, the relationship between the FOV and the TTL and the number (n) of lenses may be set. Accordingly, it is possible to set a slim size according to FOV in an optical system having 10 or more, for example, 11 lenses.

$$( TTL * n ) > FOV \qquad [ Equation 73 ]$$

When Equation 73 is satisfied, a slim optical system may be provided.

$$( v 11 * n 11 ) < ( v 1 * n 1 ) < ( v 3 * n 3 ) \qquad [ Equation 74 ]$$

In Equation 74, it is possible to set the refractive indices n1, n3, and n11 of the first, third, and eleventh lenses and the Abbe numbers v1, v3, and v11 of the first, third, and eleventh lenses, and when they are satisfied, the resolution may be controlled.

$$[ Equation 75 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + …$$

In Equation 75, Z is Sag and may mean a distance in the optical axis direction from an arbitrary position on the aspherical surface to the apex of the aspherical surface. Y may mean a distance in a direction perpendicular to the optical axis from an arbitrary position on the aspheric surface to the optical axis. The c may mean the curvature of the lens, and K may mean the conic constant. Also, A, B, C, D, E, and F may mean aspheric constants.

The optical system 1000 according to the embodiment may satisfy at least one or two or more of Equations 1 to 74. In this case, the optical system 1000 may have improved optical characteristics. In detail, when the optical system 1000 satisfies at least one or two or more of Equations 1 to 74, the optical system 1000 has improved resolution and may improve aberration and distortion characteristics. In addition, the optical system 1000 may secure a BFL for applying the large-size image sensor 300, and may minimize the distance between the last lens and the image sensor 300 and thus have good optical performance in the center and periphery portions of the FOV. In addition, when the optical system 1000 satisfies at least one of Equations 1 to 74, it may include a relatively large image sensor 300, have a relatively small TTL value, and may provide a slimmer and more compact optical system and a camera module having the same.

In the optical system 1000 according to the embodiment, the distance between the plurality of lenses 100 may have a value set according to the region.

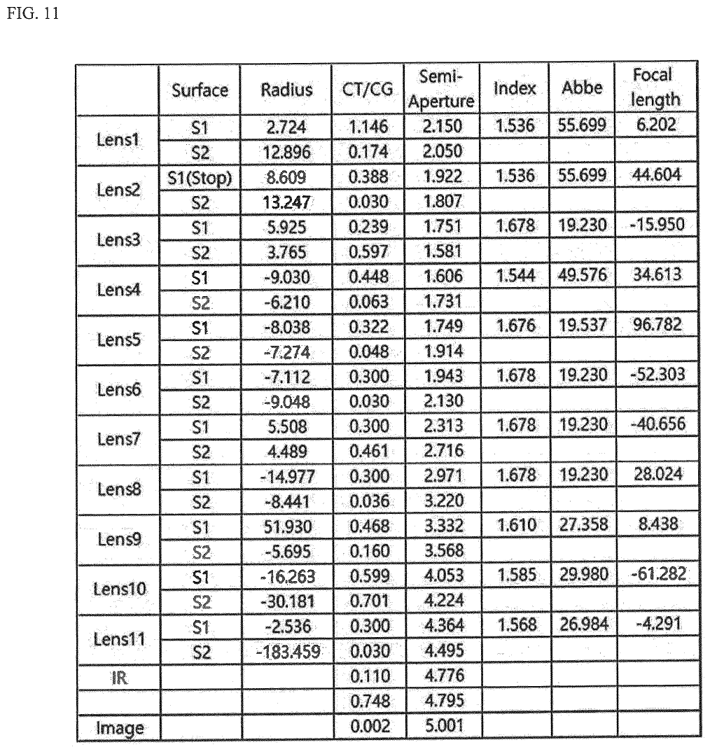

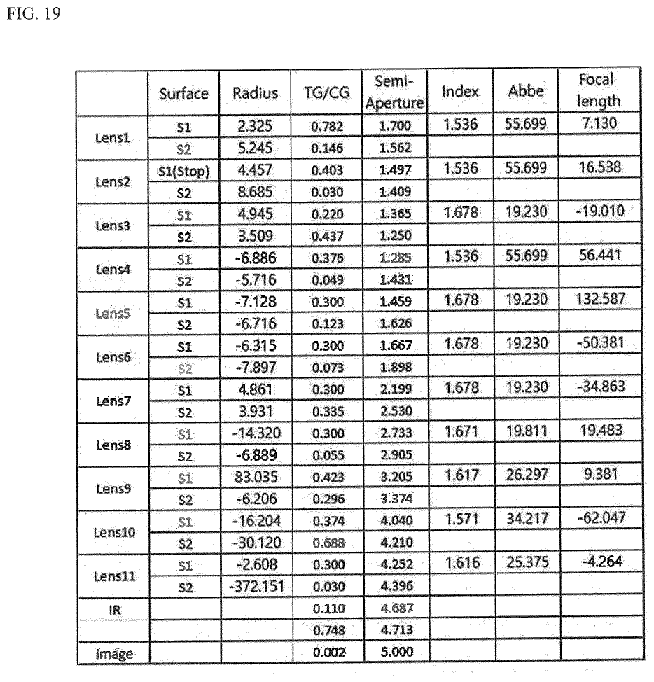

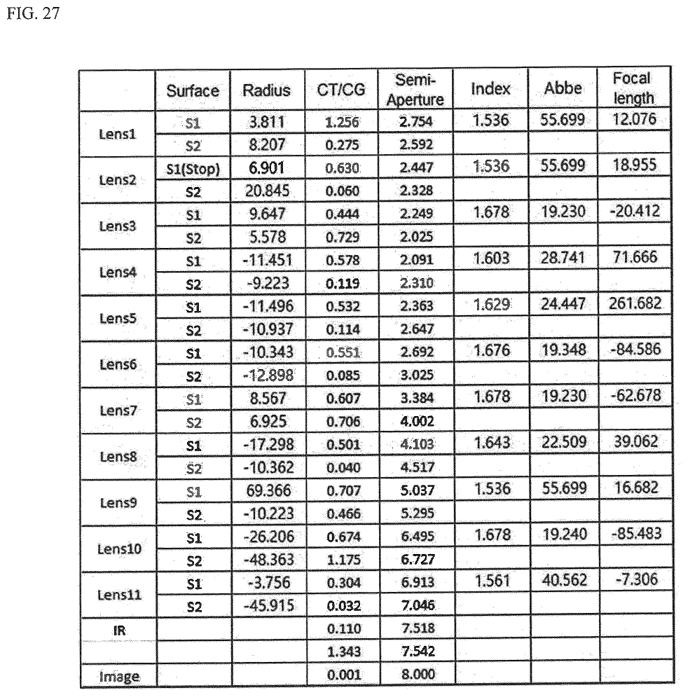

FIG. 3 is an example of lens data according to the first embodiment having the optical system of FIG. 1, FIG. 11 is an example of lens data according to the second embodiment having the optical system of FIG. 10, and FIG. 19 is an example of lens data of the optical system of FIG. 18, and FIG. 27 is a table showing lens data of the optical system of FIG. 26.

As shown in FIGS. 3, 11, 19, and 27, the optical system according to the first to fourth embodiments represents a curvature radius on the optical axis OA of the first to eleventh lenses 101 to 111, center thickness CT of each lens, and center distances CG between lenses, refractive index at d-line (588 nm), Abbe number and effective radius (Semi-Aperture), focus length. In the absolute value of the focal length, the focal length of the fifth lens 105 is maximum, and the focal length of the eleventh lens 111 is minimum and may be smaller than that of the first lens 101. In the absolute value of the curvature radius, the seventeenth surface S17 and the twenty-second surface S22 are 30 mm or more, the twenty-second surface S22 is the largest in the first to third embodiments, and the seventeenth S17 in the fourth embodiment may be maximum.

As shown in FIGS. 4, 12, 20, and 28, at least one or all of the lens surfaces of the plurality of lenses in the first to fourth embodiments may include an aspheric surface having a 30th order aspheric coefficient. For example, the first to eleventh lenses 101 to 111 may include lens surfaces having a 30th order aspheric coefficient from the first surface S1 to the twenty-second surface S22. As described above, an aspherical surface having a 30th order aspheric coefficient (a value other than “0”) may change the aspherical shape of the peripheral portion particularly greatly, so that the optical performance of the peripheral portion of the FOV may be well corrected.

Referring to FIGS. 5, 13, 21 and 29, the first to eleventh thicknesses T1 to T11 of the first to eleventh lenses 101 to 111 may be expressed as a distance of 0.1 mm or more in the direction Y from the center to the edge of each lens, and the distance between adjacent lenses may be represented by a distance of 0.1 mm or more in a direction from the center to the edge with respect to the first distance G1 between the first and second lenses, the second distance G2 between the second and third lenses, and the third distance G3 between third and fourth lenses, the fourth distance G4 between the fourth and fifth lenses, the fifth distance G5 between the fifth and sixth lenses, the sixth distance G6 between the sixth and seventh lenses, the seventh distance G7 between the seventh and eighth lenses, the eighth distance G8 between the eighth and ninth lenses, the ninth distance G9 between the ninth and tenth lenses, the tenth distance G10 between the tenth and eleventh lenses. The center distances of the tenth distance G10 may be the largest among the center distances, and the center thickness of the first lens 101 may be the largest among the center thicknesses. The optical system may be provided in a slim and compact size by using the first to eleventh thicknesses T1 to T11 and the first to tenth distances G1 to G10.

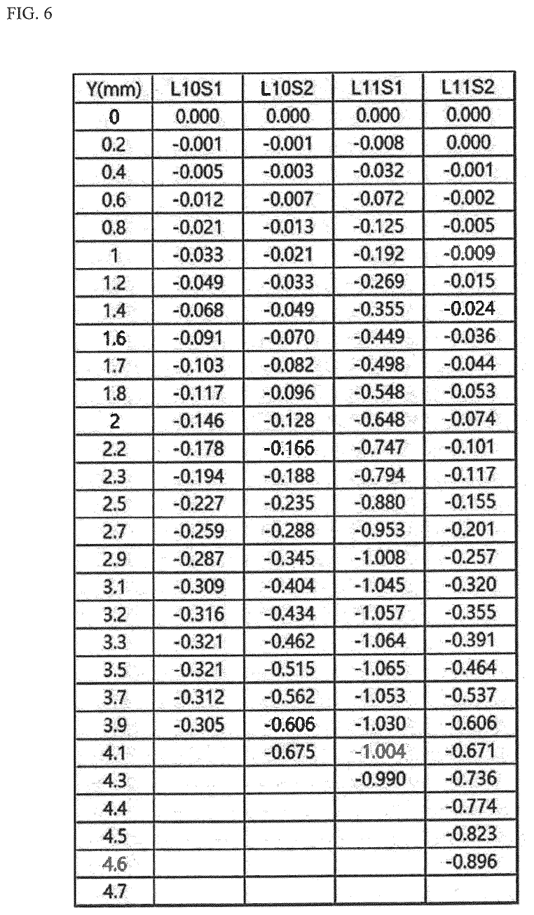

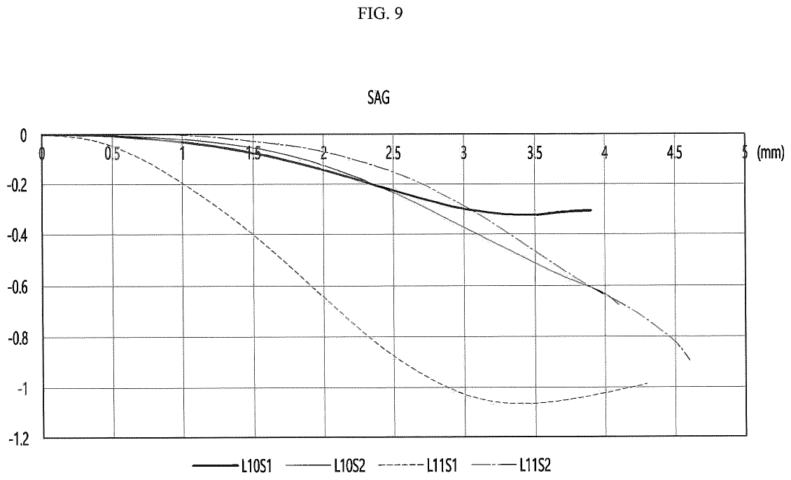

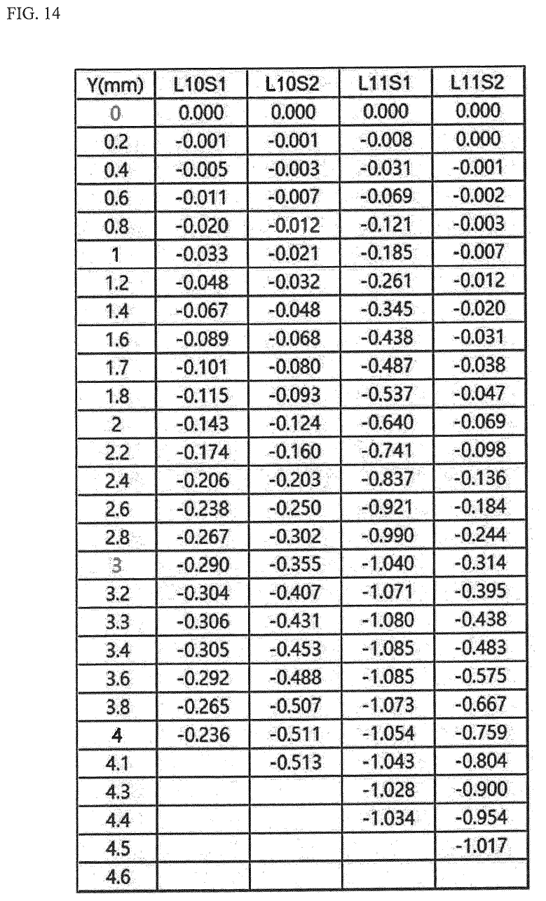

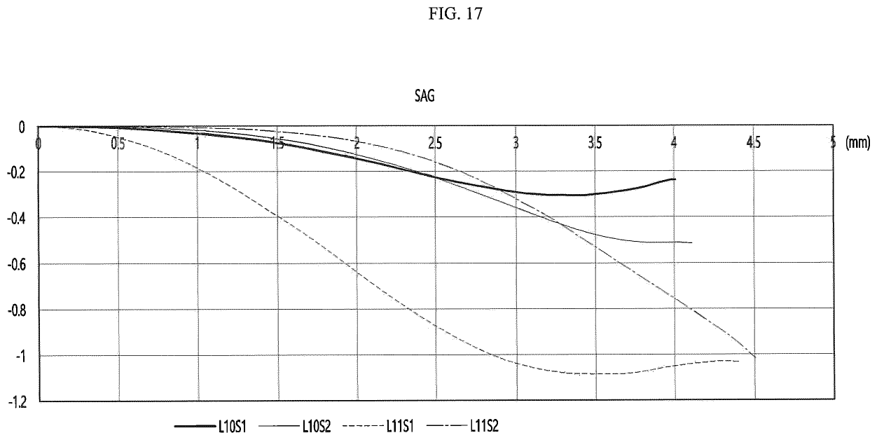

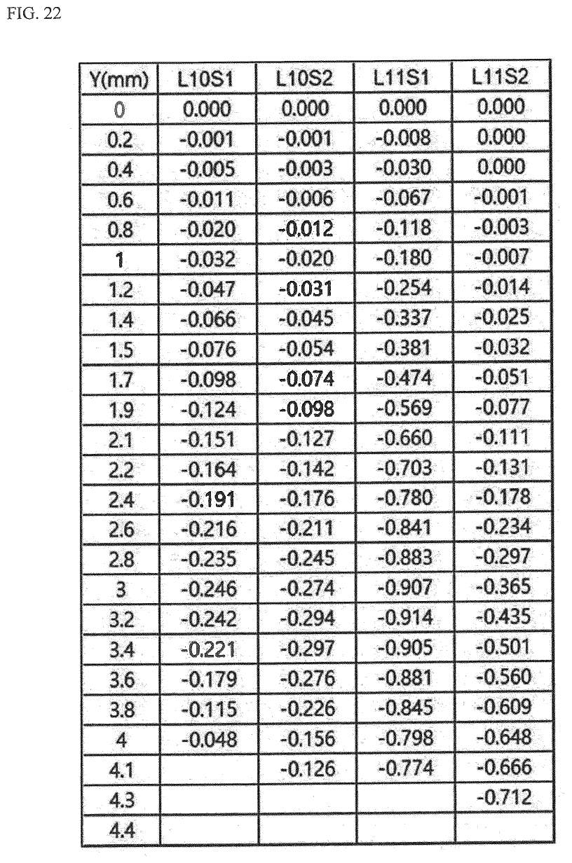

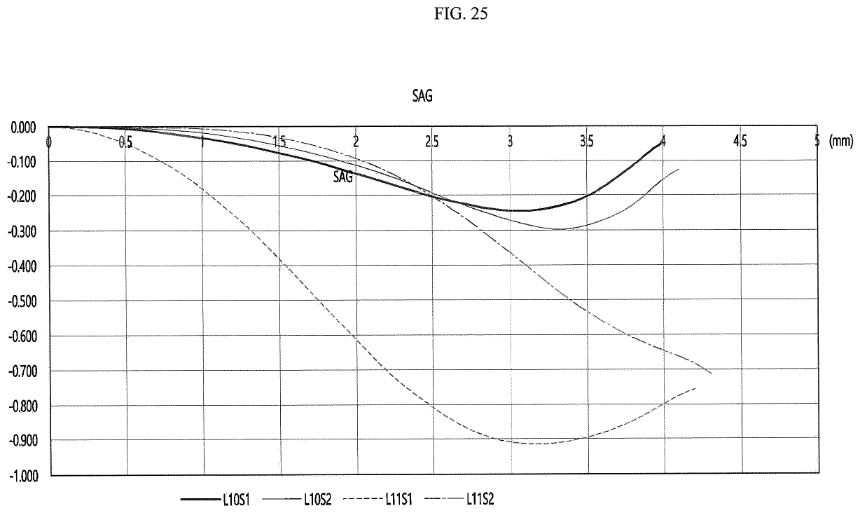

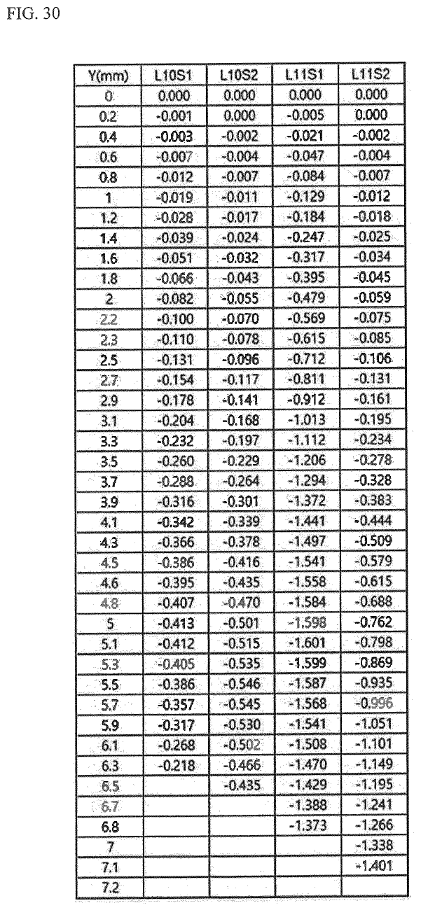

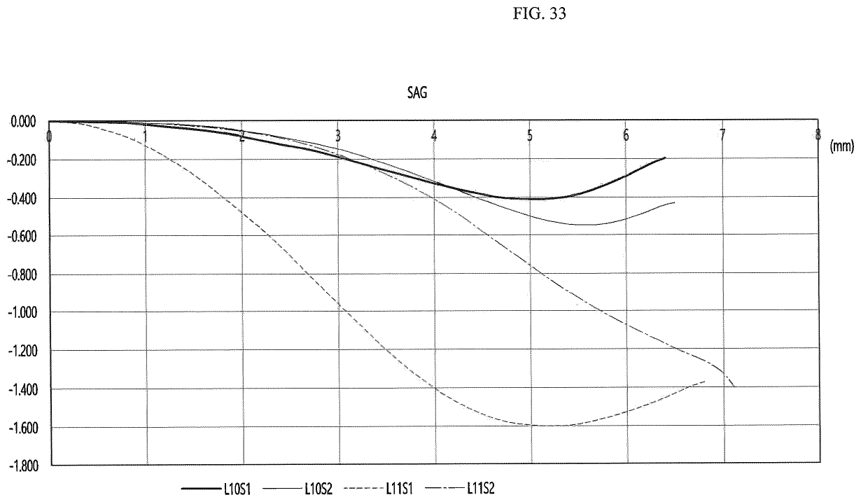

As shown in FIGS. 6, 14, 22, and 30, the object-side surface L10S1 and the sensor-side surface L10S2 of the tenth lens 110, and the object-side surface L11S1 and the sensor-side surface L11S2 of the eleventh lens 111 according to the first to fourth embodiments of the invention shows the Sag values. The Sag value may be expressed as a height (Sag value) from a straight line in the Y-axis direction perpendicular to the center of each lens surface to the lens surface at intervals of 0.1 or more. FIGS. 9 and 17 are graphs showing Sag values of the object-side and sensor-side surfaces of the ninth lens and the object-side and sensor-side surfaces of the tenth lens, which are disclosed in FIGS. 6 and 14. As shown in FIGS. 9, 17, 25 and 33, it may be seen that the object-side surface L10S1 and the sensor-side surface L10S2 of the tenth lens 110 protrude in the object side direction based on a straight line perpendicular to the optical axis, it may be seen that a position of the critical point occurs at a position of 4 mm or more from the optical axis. The object-side surface L11S1 and the sensor-side surface L11S2 of the eleventh lens 111 protrude in the object-side direction based on a straight line orthogonal to the optical axis, it may be seen that a position of the critical point of the object-side surface L11S1 occurs at a position of 4 mm or more from the optical axis, and it may be seen that the sensor-side surface L11S2 is provided without a critical point. In addition, it may be seen that each of the sensor-side surface L10S2 or/and object-side surface L10S1 of the tenth lens is closer to the object side than a straight line orthogonal to the center of each lens surface and the critical point may be located at a position adjacent to the edge region. It may be seen that each of the object-side surfaces L11S1 of the eleventh lens is closer to the object side than a straight line orthogonal to the center of each object-side surface L11S1 and the critical point is located adjacent to the edge region.

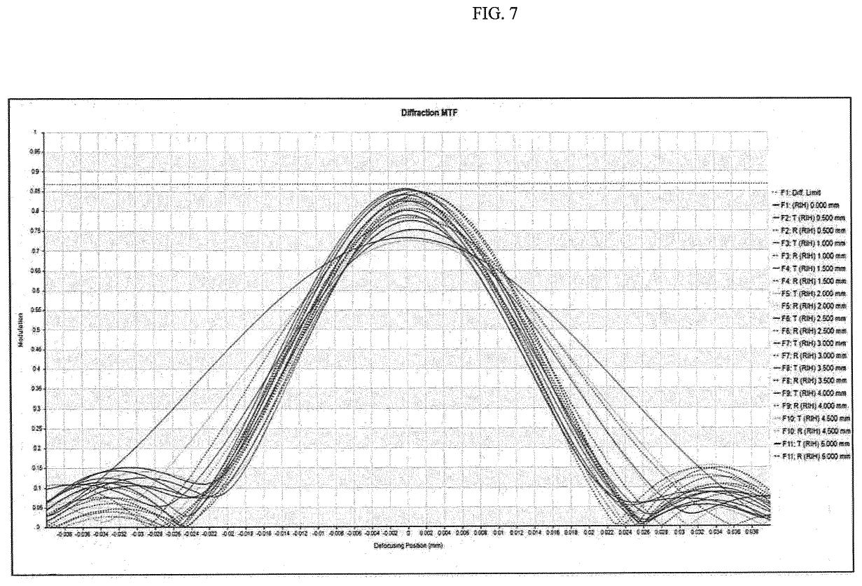

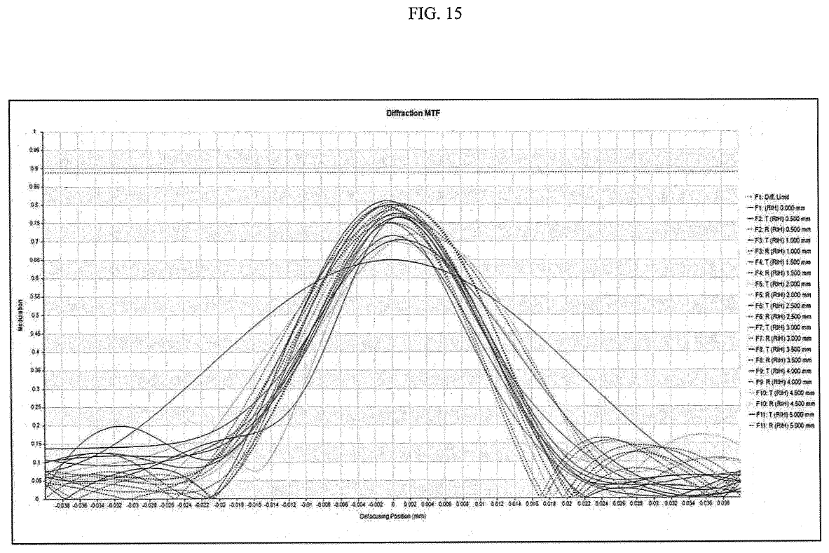

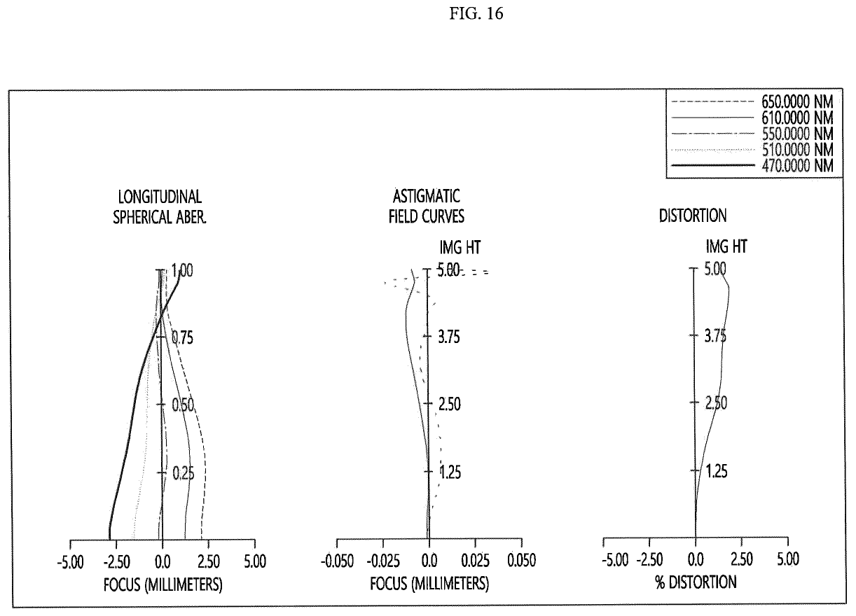

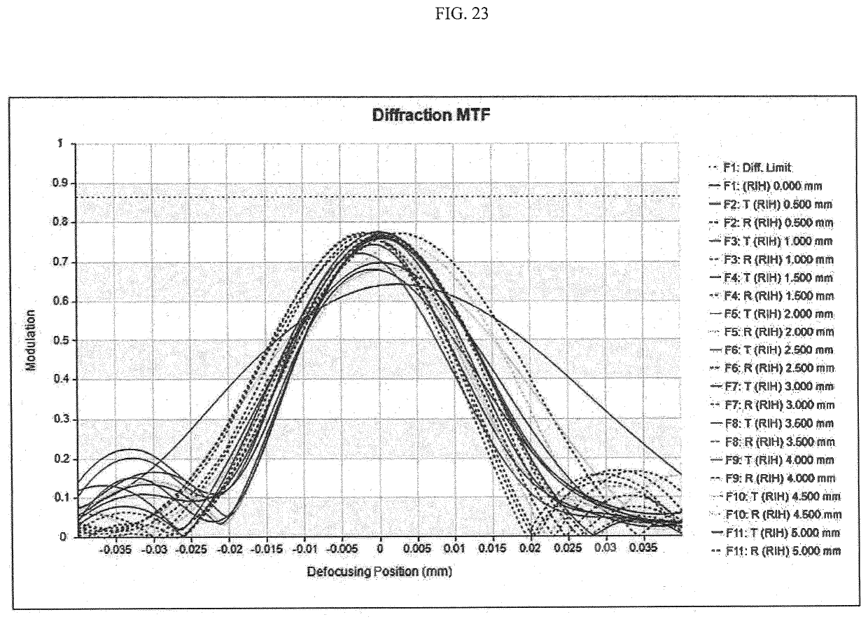

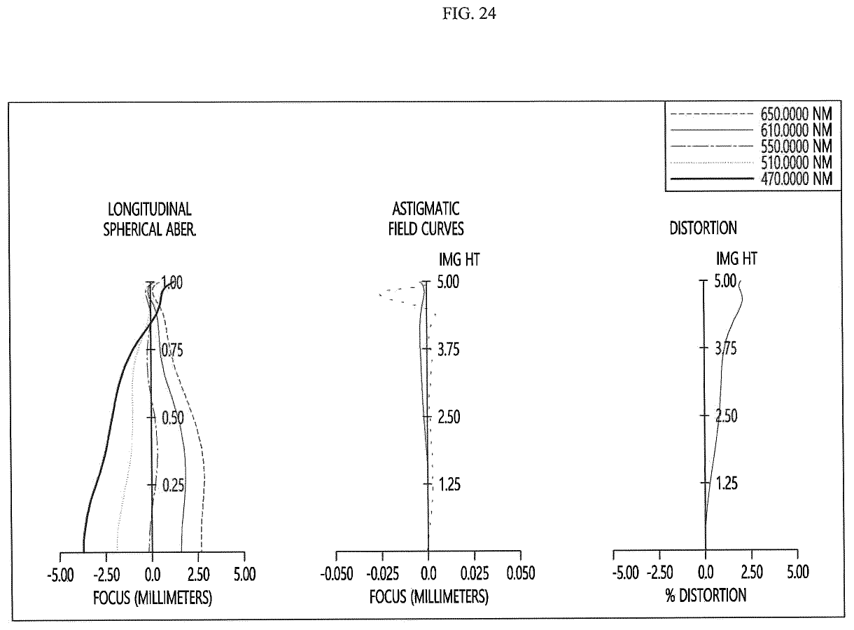

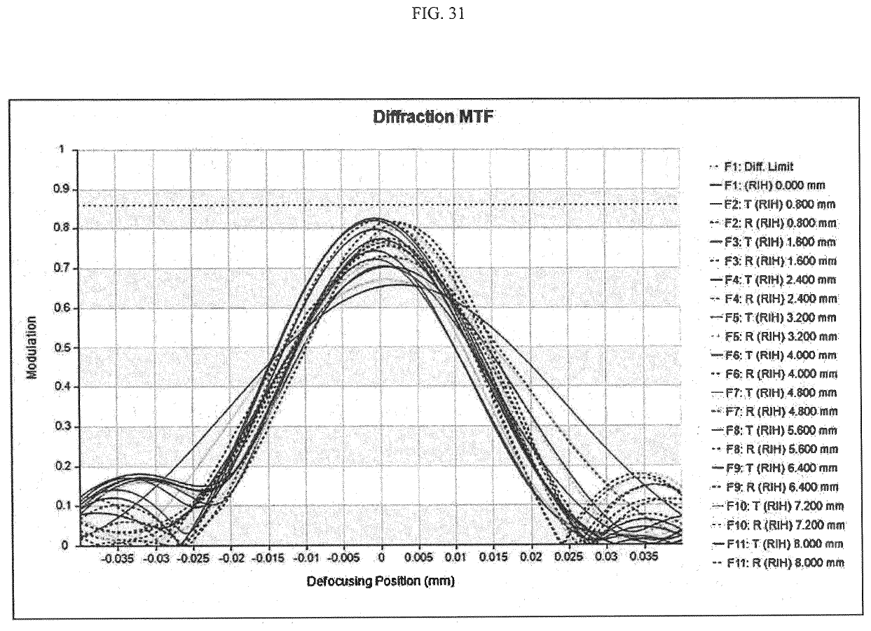

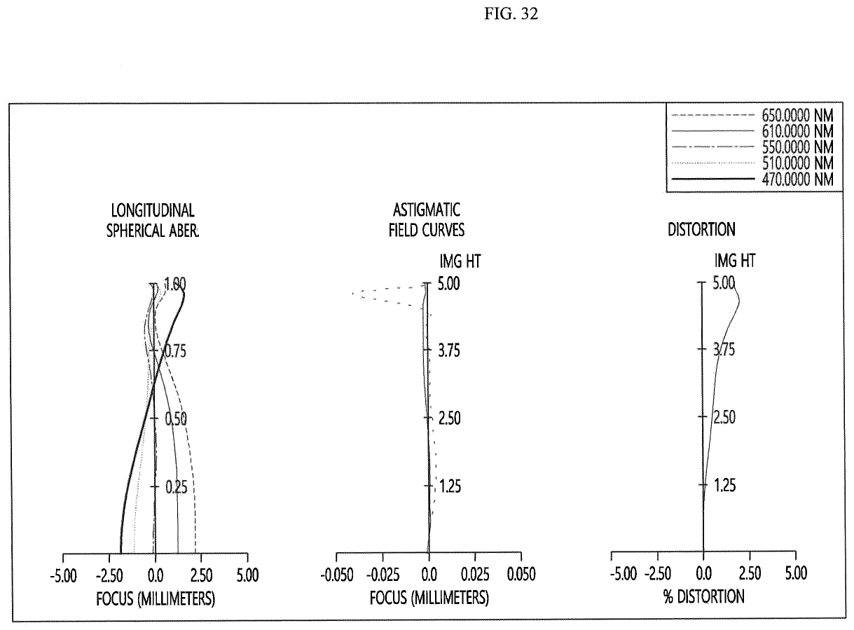

Accordingly, the optical system 1000 according to the first to fourth embodiments may have good optical performance in the center and periphery portions of the FOV, and FIGS. 7, 8, 15, 16, 23, 24, and 31 and 32 may have excellent optical properties.

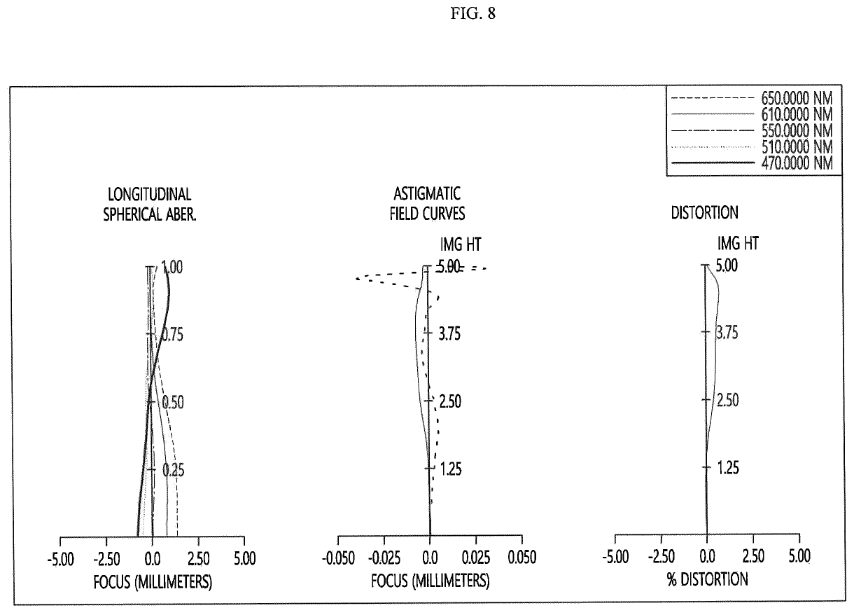

In the aberration graphs of FIGS. 7, 15, 23, and 31, spherical aberration, astigmatic field curves, and distortion are measured from left to right. In FIGS. 8, 16, 24, and 32, the X-axis may mean a focal length (mm) and distortion (%), and the Y-axis may mean the height of an image. In addition, a graph of spherical aberration is a graph of light in a wavelength band of about 470 nm, about 510 nm, about 555 nm, about 610 nm, and about 650 nm, and a graph of astigmatism and distortion is a graph of light in a wavelength band of 555 nm. In the aberration diagrams of FIGS. 8, 16, 24 and 32, it may be interpreted that the aberration correction function is better as each curve approaches the Y-axis. Referring to FIGS. 8, 16, 24 and 32, in the optical system 1000 according to the embodiments, it may be seen that measurement values are adjacent to the Y-axis in almost all regions. That is, the optical system 1000 according to the first to fourth embodiments may have improved resolution and good optical performance not only at the center portion but also at the periphery portion of the FOV. As confirmed in the above embodiments, the lens system of the first to fourth embodiments according to the invention has a lens configuration of 10 or more, for example, 11 lenses, and is compact and lightweight, and at the same time, spherical aberration, astigmatism, distortion aberration, chromatic aberration, and coma aberration are all good. Since it may be calibrated and implemented with high resolution, it may be used by being embedded in the optical device of the camera.

Table 1 relates to the items of the equations described above in the optical system 1000 according to the first to fourth embodiments, and relates the total track length (TTL), back focal length (BFL), and F value, which is total effective focus length, ImgH, the focal lengths (F1, F2, F3, F4, F5, F6, F7, F8, F9, and F10) of each of the first to eleventh lenses, the edge thickness of each lens, and edge distance between adjacent lenses, composite focal length, entrance pupil diameter (EPD), FOV, and the like of the optical system 1000.

TABLE 1

| Items | Embodiment 1 | Embodiment 2 | Embodiment 3 | Embodiment 4 |
|---|---|---|---|---|
| F | 7.114 | 6.629 | 6.136 | 10.474 |
| F1 | 6.309 | 6.202 | 7.130 | 12.076 |
| F2 | 33.814 | 44.604 | 16.538 | 18.955 |
| F3 | −13.437 | −15.950 | −19.010 | −20.412 |
| F4 | 29.810 | 34.613 | 56.441 | 71.666 |
| F5 | 112.264 | 96.782 | 132.587 | 261.682 |
| F6 | −55.605 | −52.303 | −50.381 | −84.586 |
| F7 | −34.033 | −40.656 | −34.863 | −62.678 |
| F8 | 27.242 | 28.024 | 19.483 | 39.062 |
| F9 | 9.155 | 8.438 | 9.381 | 16.682 |
| F10 | −53.127 | −61.282 | −62.047 | −85.483 |
| F11 | −4.424 | −4.291 | −4.264 | −7.306 |
| F13 | 7.508 | 7.246 | 6.333 | 10.586 |
| F411 | −13.415 | −15.442 | −11.693 | −17.347 |
| ET1 | 0.392 | 0.257 | 0.250 | 0.432 |
| ET2 | 0.299 | 0.250 | 0.249 | 0.340 |
| ET3 | 0.406 | 0.389 | 0.304 | 0.604 |
| ET4 | 0.252 | 0.250 | 0.250 | 0.390 |
| ET5 | 0.346 | 0.264 | 0.266 | 0.455 |
| ET6 | 0.266 | 0.313 | 0.300 | 0.487 |
| ET7 | 0.448 | 0.387 | 0.301 | 0.753 |
| ET8 | 0.422 | 0.314 | 0.306 | 0.651 |
| ET9 | 0.301 | 0.300 | 0.299 | 0.373 |
| ET10 | 0.309 | 0.300 | 0.299 | 0.415 |
| ET11 | 0.447 | 0.316 | 0.296 | 0.309 |
| EG1 | 0.263 | 0.263 | 0.182 | 0.335 |
| EG2 | 0.103 | 0.080 | 0.085 | 0.153 |
| EG3 | 0.179 | 0.050 | 0.048 | 0.098 |
| EG4 | 0.059 | 0.050 | 0.050 | 0.098 |
| EG5 | 0.076 | 0.093 | 0.071 | 0.086 |
| EG6 | 0.268 | 0.212 | 0.247 | 0.474 |
| EG7 | 0.208 | 0.269 | 0.218 | 0.136 |
| EG8 | 0.051 | 0.050 | 0.136 | 0.225 |
| EG9 | 0.314 | 0.446 | 0.612 | 0.960 |
| EG10 | 0.400 | 0.205 | 0.051 | 0.258 |
| FOV | 6.378 | 6.656 | 77.227 | 73.759 |
| EPD | 0.353 | 0.390 | 3.3061 | 5.426 |
| BFL | 0.086 | 0.081 | 0.8900 | 1.486 |
| TD | 0.678 | 0.646 | 6.3100 | 10.554 |
| ImgH | 0.455 | 0.455 | 5.0000 | 8.000 |
| SD | 0.564 | 0.529 | 5.4120 | 9.055 |
| F# | 1.830 | 1.544 | 1.856 | 1.931 |
| TTL | 8.403 | 8.000 | 7.200 | 12.040 |

Table 2 shows the resultant values of Equations 1 to 40 described above in the optical system 1000 of FIG. 1. Referring to Table 2, it may be seen that the optical system 1000 satisfies at least one, two or more, or three or more of Equations 1 to 40. In detail, it may be seen that the optical system 1000 according to the embodiment satisfies all of Equations 1 to 40 above. Accordingly, the optical system 1000 may improve optical performance and optical characteristics at the center and periphery portions of the FOV.

TABLE 2

| | | Embodiment | Embodiment | Embodiment | Embodiment |
|---|---|---|---|---|---|
| | Equations | 1 | 2 | 3 | 4 |
| 1 | 2 < CT3/CT1 < 7 | 3.788 | 4.799 | 3.555 | 2.829 |
| 2 | 0.3 < CT3/ET3 < 2 | 0.705 | 0.614 | 0.723 | 0.735 |
| 3 | 3 < ΣCT − CT_Aver < 7 | 4.641 | 4.372 | 3.707 | 6.168 |
| 4 | 1.6 < n3 | 1.678 | 1.678 | 1.678 | 1.678 |
| 5 | 0.5 < L11S2_max_sag to Sensor < 1.5 | 0.945 | 0.890 | 0.890 | 1.486 |
| 6 | 0.9 < BFL/L11S2_max_sag to Sensor < 2 | 1.000 | 1.000 | 0.269 | 0.274 |
| 7 | 5 < \|L11S2_max slope\| < 45 | 42.000 | 34.000 | 35.000 | 38.000 |
| 8 | −5 < \|L11S2_max slope\| − \|L10S2_max slope\| < 30 | 14.000 | 19.000 | 26.000 | −3.000 |
| 9 | 10 < CG10/G10_min < 60 | 14.328 | 56.965 | 17.119 | 23.363 |
| 10 | 1 < CG10/EG10 < 5 | 1.793 | 3.420 | 13.494 | 4.550 |
| 11 | 0.01 < CG2/CG4 < 1 | 0.660 | 0.476 | 0.613 | 0.499 |
| 12 | 1 < CT1/CT11 < 5 | 3.616 | 3.820 | 2.607 | 4.134 |
| 13 | 1 < CT10/CT11 < 5 | 2.259 | 1.996 | 1.246 | 2.217 |
| 14 | 5 < L10R2/L11R1 < 20 | 12.052 | 11.902 | 11.548 | 12.876 |
| 15 | 0 < (CG10 − EG10)/(CG10) < 2 | 0.442 | 0.708 | 0.926 | 0.780 |
| 16 | 1 < CA_L1S1/CA_L3S1 < 2 | 1.275 | 1.228 | 1.246 | 1.225 |
| 17 | 1 < CA_L11S2/CA_LAS2 < 5 | 2.724 | 2.597 | 3.072 | 3.051 |
| 18 | 0.8 < CA_L4S2/CA_L3S2 < 2 | 1.189 | 1.095 | 1.145 | 1.140 |
| 19 | 0.1 < CA_L10S2/CA_L11S2 ≤1 | 0.904 | 0.940 | 0.958 | 0.955 |
| 20 | 1 < CG3/EG3 < 15 | 3.436 | 11.926 | 9.177 | 7.432 |
| 21 | 0 < CG9/EG9 < 1 | 0.341 | 0.358 | 0.484 | 0.485 |
| 22 | 0.5 < G10_max/CG10 < 2 | 1.000 | 1.000 | 0.058 | 0.047 |
| 23 | 0 < CT10/CG10 < 1 | 0.946 | 0.854 | 0.543 | 0.573 |
| 24 | 0.1 < CT11/CG10 < 1 | 0.419 | 0.428 | 0.436 | 0.259 |
| 25 | (CT8 + CT9 + CT10) > (CG7 + CG8 + CG9 + CG10) | Satisfaction | Satisfaction | Satisfaction | Satisfaction |
| 26 | 0 < CT9/CG10 < 1 | 0.712 | 0.668 | 0.615 | 0.602 |
| 27 | 0 < \|L10R1/CT10\| < 50 | 23.601 | 27.166 | 43.359 | 38.902 |
| 28 | 1 < L10R1/L11R1 < 10 | 6.518 | 6.414 | 6.213 | 6.977 |
| 29 | 0 < CT_Max/CG_Max < 2 | 1.514 | 1.636 | 1.136 | 1.069 |
| 30 | 0.5 < ΣCT/ΣCG < 5 | 2.169 | 2.091 | 1.826 | 1.800 |
| 31 | 10 < ΣIndex < 30 | 17.734 | 17.797 | 17.792 | 17.752 |
| 32 | 10 < ΣAbb/ΣIndex < 50 | 20.635 | 19.193 | 19.656 | 20.302 |
| 33 | 0 < \|Max_distoriton\| < 5 | 0.756 | 2.000 | 2.000 | 1.926 |
| 34 | 0 < EG_Max/CT_Max < 2 | 0.368 | 0.389 | 0.783 | 0.764 |
| 35 | 0.5 < CA_L1S1/CA_min < 2 | 1.400 | 1.360 | 1.360 | 1.360 |
| 36 | 1 < CA_max/CA_min < 7 | 3.239 | 2.843 | 3.517 | 3.479 |
| 37 | 1 < CA_max/CA_Aver < 4 | 1.800 | 1.717 | 1.860 | 1.867 |
| 38 | 0.1 < CA_min/CA_Aver < 1 | 0.556 | 0.604 | 0.529 | 0.537 |
| 39 | ΣCA*n > 1100 | 1219.005 | 1267.009 | 1143.817 | 1826.952 |
| 40 | 50 < (CA_Max − CA_Min)*n < 120 | 68.946 | 64.103 | 69.207 | 110.463 |

Table 3 shows for the resultant values of Equations 41 to 74 described above in the optical system 1000 of FIG. 1. Referring to Table 3, the optical system 1000 may satisfy at least one or two or more of Equations 1 to 40 and at least one, two or more, or three or more of Equations 41 to 74. In detail, it may be seen that the optical system 1000 according to the embodiment satisfies all of Equations 1 to 74 above. Accordingly, the optical system 1000 may improve optical performance and optical characteristics at the center and periphery portions of the FOV.

TABLE 3

| | | Embodiment | Embodiment | Embodiment | Embodiment |
|---|---|---|---|---|---|
| Equations | | 1 | 2 | 3 | 4 |
| 41 | 0.1 < CA_max/(2*ImgH) < 1.5 | 0.907 | 0.899 | 0.879 | 0.881 |
| 42 | 0.1 < TD/CA_max < 1.5 | 0.823 | 0.791 | 0.101 | 0.105 |
| 43 | 0 < \|F/L11R2\| < 1 | 0.064 | 0.036 | 0.016 | 0.228 |
| 44 | 1 < F/L1R1 < 10 | 2.560 | 2.434 | 2.639 | 2.748 |
| 45 | 0 < \|EPD/L11R2\| < 1 | 0.035 | 0.023 | 0.208 | 0.118 |
| 46 | 0.5 < EPD/L1R1 < 8 | 1.399 | 1.576 | 1.422 | 1.424 |
| 47 | −3 < F1/F3 < 0 | −0.470 | −0.389 | −0.375 | −0.592 |
| 48 | 1 < F13/F < 5 | 1.055 | 1.093 | 1.032 | 1.011 |
| 49 | 3 < \|F411/F13\| < 15 | 1.787 | 2.131 | 1.846 | 1.639 |
| 50 | 2 < TTL < 20 | 8.403 | 8.000 | 7.200 | 12.040 |
| 51 | 2 < ImgH | 5.001 | 5.001 | 5.000 | 8.000 |
| 52 | BFL < 2.5 | 0.945 | 0.890 | 0.890 | 1.486 |
| 53 | 2 < F < 20 | 7.114 | 6.629 | 6.136 | 10.474 |
| 54 | FOV < 120 | 70.155 | 73.216 | 77.227 | 73.759 |
| 55 | 0.1 < TTL/CA_max < 2 | 0.927 | 0.890 | 0.819 | 0.854 |
| 56 | 0.5 < TTL/ImgH < 3 | 1.680 | 1.600 | 1.440 | 1.505 |
| 57 | 0.01 < BFL/ImgH < 0.5 | 0.189 | 0.178 | 0.178 | 0.186 |
| 58 | 5 < TTL/BFL < 15 | 8.895 | 8.989 | 8.090 | 8.104 |
| 59 | 0.5 < F/TTL < 1.5 | 0.847 | 0.829 | 0.852 | 0.870 |
| 60 | 3 < F/BFL < 10 | 7.530 | 7.448 | 6.895 | 7.050 |
| 61 | 0.5 < F/ImgH < 3 | 1.423 | 1.326 | 1.227 | 1.309 |
| 62 | 1 < F/EPD < 5 | 1.830 | 1.544 | 1.856 | 1.931 |
| 63 | 0 < BFL/TD < 0.3 | 0.127 | 0.125 | 1.000 | 0.141 |
| 64 | 0 < EPD/ImgH/FOV < 0.2 | 0.011 | 0.012 | 0.009 | 0.009 |
| 65 | 10 < FOV/F# < 70 | 38.331 | 47.409 | 41.608 | 38.207 |
| 66 | 0 < n1/n2 < 1.5 | 0.996 | 1.000 | 1.000 | 1.000 |
| 67 | 0 < n3/n4 < 1.5 | 1.089 | 1.087 | 1.092 | 1.047 |
| 68 | 2 ≤ (CA_L11S2/CA_L3S2)/ | 2.313 | 2.091 | 2.586 | 2.558 |
| | (CA_L1S1/CA_L3S2) < 5 | | | | |
| 69 | 13 < (TTL/ImgH)*n < 23 | 18.484 | 17.598 | 15.840 | 16.555 |
| 70 | 21 < (TD_LG2/TD_LG1)*n < 31 | 26.079 | 25.239 | 29.871 | 29.551 |
| 71 | 5 < (CT_Max + CG_Max)*n < 12 | 7.265 | 6.726 | 9.680 | 10.290 |
| 72 | 40 < (FOV*TTL)/n < 63 | 53.593 | 53.248 | 50.549 | 80.733 |
| 73 | (TTL*n) > FOV | Satisfaction | Satisfaction | Satisfaction | Satisfaction |
| 74 | (v11*n11) < (v1*n1) < (v3*n3) | Satisfaction | Satisfaction | Satisfaction | Satisfaction |

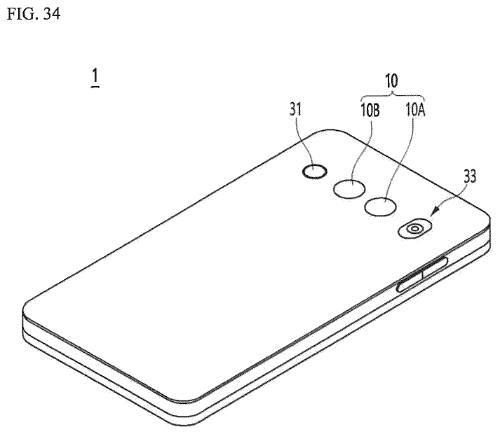

FIG. 34 is a diagram illustrating that a camera module according to an embodiment is applied to a mobile terminal. Referring to FIG. 34, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy. In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to eleventh lenses disposed along an optical axis from an object side toward a sensor side,
wherein the first lens has a positive (+) refractive power on the optical axis and has a convex object-side surface,
wherein a refractive index n3 of the third lens and a refractive index n4 of the fourth lens satisfy the following Equation: 1<n3/n4<1.5,
wherein a number of meniscus-shaped lenses convex toward the object side on the optical axis of the first to eleventh lenses is four or more,
wherein a sensor-side surface of the eleventh lens is provided without a critical point from the optical axis to an end of an effective region, and
wherein a maximum distance from the optical axis to a point where a height between a straight line orthogonal to the optical axis and the sensor-side surface is less than 0.1 is a first distance, and the first distance is disposed at a position of 20% or more of an effective radius of the sensor-side surface of the eleventh lens.

2. The optical system of claim 1,
wherein a difference between a maximum slope angle L10S2_max slope of a tangent passing through a sensor-side surface of the tenth lens and a maximum slope angle L11S2_max slope of a tangent passing through the sensor-side surface of the eleventh lens satisfies the following Equation:
$$10 < \vert L11S2\_max slope \vert - \vert L10S2\_max slope \vert < 30 . \qquad Equation$$

3. The optical system of claim 2,
wherein an effective radius of the sensor-side surface of the eleventh lens is less than 5 mm.

4. The optical system of claim 1,
wherein a difference between a maximum slope angle L10S2_max slope of a tangent passing through a sensor-side surface of the tenth lens and a maximum slope angle L11S2_max slope of a tangent passing through the sensor-side surface of the eleventh lens satisfies the following Equation:
$$- 5 < \vert L11S2\_max slope \vert - \vert L10S2\_max slope \vert < 5 . \qquad Equation$$

5. The optical system of claim 4,
wherein an effective radius of the sensor-side surface of the eleventh lens is 6 mm or more.

6. The optical system of claim 1,
wherein an effective diameter CA_L11S2 of the eleventh lens and a center distance CG10 between and the tenth and eleventh lenses satisfies the following Equation:
$$3 < CA\_L11S2 / CG 10 < 20 . \qquad Equation$$

7. The optical system of claim 1,
wherein an effective diameter CA_L10S2 of the tenth lens and a center distance CG10 between the tenth and eleventh lenses satisfies the following Equation:
$$5 < CA\_L10S2 / CG 10 < 15 . \qquad Equation$$

8. The optical system of claim 1,
wherein a maximum effective diameter CA_Max of an object-side surface and a sensor-side surface of the first to eleventh lenses and a distance ImgH from a center of an image sensor to a diagonal end thereof satisfy the following Equation:
$$0.5 \leq CA\_Max / ( 2 * ImgH ) < 1 . \qquad Equation$$

9. The optical system of claim 1,
wherein refractive indices n1, n2, and n3 of the first to third lenses satisfy the following Equations:
$$1.50 < n 1 < 1.6 \qquad Equations$$
$$1.5 < n 2 < 1.6$$
$$17 < n 3 * n$$
(n is a total number of lenses).

10. The optical system of claim 1,
wherein the first, second, third and seventh lenses have a meniscus shape convex toward the object side on the optical axis.

11. The optical system of claim 10,
wherein the tenth and eleventh lenses have a convex meniscus shape toward the sensor side on the optical axis.

12. The optical system of claim 1,
wherein a sum ΣCA of effective diameters of an object-side surface and a sensor-side surface of the first to eleventh lenses satisfies the following Equation:
$$\sum CA * n > 1100$$
where n is a number of total lenses.

13. An optical system comprising:
a first lens group having a plurality of lenses aligned along an optical axis on an object side;
a second lens group having a plurality of lenses aligned along the optical axis on a sensor side of the first lens group; and
an aperture stop disposed around one lens of the first lens group,
wherein a number of lenses of the second lens group is more than twice a number of lenses of the first lens group,
wherein the lenses of the first lens group have a meniscus shape convex toward the object side on the optical axis,
wherein a n-th lens closest to an image sensor in the second lens group and a n−1-th lens on the object side of the n-th lens have a meniscus shape convex toward the sensor side on the optical axis,
wherein a sensor-side surface of a lens closest to the second lens group among the lenses of the first lens group has a concave shape on the optical axis,
wherein an object-side surface of a lens closest to the first lens group among the lenses of the second lens group has a concave shape on the optical axis,
wherein effective diameters of an object-side surface and a sensor-side surface of first to third lenses gradually decrease from the object side toward the sensor side, and
wherein effective diameters of the lenses in the second lens group gradually increase from an effective diameter of the object-side surface of the lens closest to the first lens group to an effective diameter of a sensor-side surface of a last lens closest to the image sensor.

14. The optical system of claim 13,
wherein effective diameters of the lenses of the first lens group gradually increase from an effective diameter of the sensor-side surface of the lens closest to the second lens group to an effective diameter of the object-side surface of the first lens.

15. The optical system of claim 13,
wherein a distance from the image sensor to a center of the sensor-side surface of the last lens is equal to a distance from a maximum Sag value of the sensor-side surface of the last lens to the image sensor.

16. The optical system of claim 13,
wherein a minimum effective diameter CA_Min and a maximum effective diameter CA_Max among the lenses of the first and second lens groups satisfy the following Equation:
$$50 < ( CA\_Max - CA\_Min ) * n < 120$$
where n is a total number of lenses.

17. The optical system of claim 13,
wherein a difference between an optical axis distance TD_LG1 of the first lens group and an optical axis distance TD_LG2 of the second lens group satisfies the following Equation:
$$21 < ( TD\_LG2 / TD\_LG1 ) * n < 31 \qquad Equation$$
(n is a total number of lenses).

18. The optical system of claim 13,
wherein a lens having a maximum center thickness is a first lens closest to the object,
wherein two lenses having a maximum center distance are the n-th lens and the n−1th lens,
wherein the maximum center thickness CT_Max of the lenses of the first and second lens groups and the maximum center distance CG_Max between adjacent lenses satisfy the following Equation:
$$5 < ( CT\_Max + CG\_Max ) * n < 12$$
(n is a total number of lenses).

19. (canceled)

20. The optical system of claim 13,
wherein the first lens group includes first to third lenses,
wherein the second lens group includes fourth to eleventh lenses,
wherein a composite focal length from the first lens to the third lens is F13,
wherein a composite focal length from the fourth lens to the eleventh lens is F411, and
wherein the following Equation: 3<|F411/F13|<15.

21. A camera module comprising:
an image sensor;
an optical system disposed on the image sensor; and
an optical filter disposed between the image sensor and a last lens of the optical system,
wherein the optical system includes an optical system according to claim 1,
wherein the following equations satisfy:
$$0.5 < F / TTL < 1.5 \qquad Equation$$
$$0.5 < TTL / ImgH < 3$$
$$40 \leq ImgH * n < 120$$
(F is an average of total focal lengths in two directions orthogonal to the optical axis of the optical system, and TTL (Total track length) is a distance from a center of an object-side surface of the first lens to an image surface of the image sensor in the optical axis, ImgH is ½ of a maximum diagonal length of the image sensor, and n is a total number of lenses).
